(19) United States
(12) Patent Application Publication
(10) Pub. No.: US 2022/0101239 A1
(43) Pub. Date: Mar. 31, 2022

(54) TECHNOLOGIES FOR COORDINATING PUBLIC SAFETY EMPLOYEE MANAGEMENT PROGRAMS

(71) Applicant: AGENCY 360, LLC, Fishers, IN (US)

(72) Inventor: Matthew Molter, Fishers, IN (US)

(21) Appl. No.: 17/481,823

(22) Filed: Sep. 22, 2021

Related U.S. Application Data
(60) Provisional application No. 63/083,485, filed on Sep. 25, 2020.

(51) Int. Cl. G06Q 10/06; G06F 9/451; G06Q 50/26

(52) U.S. Cl. CPC G06Q 10/06398; G06Q 10/063112; G06Q 50/26; G06F 9/453; G06Q 10/063114

(57) ABSTRACT

Technologies for coordinating public safety employee management programs include a compute device. The compute device includes circuitry configured to provide, to a user compute device, a dashboard associated with an employee management program for managing personnel of a public safety organization. The circuitry is also configured to receive, from the user compute device, user input associated with the dashboard. Additionally, the circuitry is configured to update, as a function of the user input, the employee management program.

### CROSS-REFERENCE TO RELATED APPLICATION

This application claims the benefit, under 35 U.S.C. § 119(e), of U.S. Provisional Patent Application No. 63/083,485, filed Sep. 25, 2020, the entirety of which is hereby expressly incorporated by reference herein.

### BACKGROUND

Organizations such as those that provide services to ensure public safety (e.g., law enforcement organizations, emergency medical services organizations, correctional facilities, 911 (e.g., emergency) dispatch centers, private security, etc.) rely on specialized onboarding, training, and ongoing education of their personnel to perform the services effectively. Typically, employee management programs are carried out using a vast amount of paper-based forms, for tracking the progress of employees and providing feedback and correction to the employees, who may be in an onboarding process or have progressed past the onboarding process and are working on their own (e.g., anywhere in an employee lifecycle). While the data regarding each employee's progress is recorded using the forms (e.g., for later reference), visualizing the progress of each employee over time based on the collected data is impracticable. As such, areas in which a particular employee or a group of employees are lacking (e.g., due to a deficiency in an employee management program) may go unnoticed in conventional systems. Furthermore, making changes to an employee management program (e.g., to correct for a deficiency) and implementing the changes across an organization may, in some cases, be difficult or impossible in view of the time and resources required to make the changes (e.g., by creating new paper-based forms, instructing and ensuring that personnel use the new forms, etc.).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for coordinating employee management programs;

FIG. 2 is a simplified block diagram of at least one embodiment of a compute device of the system of FIG. 1;

FIGS. 3-8 are simplified block diagrams of at least one embodiment of a method for coordinating one or more employee management programs that may be performed by the system of FIG. 1; and

FIGS. 9-43 are embodiments of user interfaces that may be produced by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

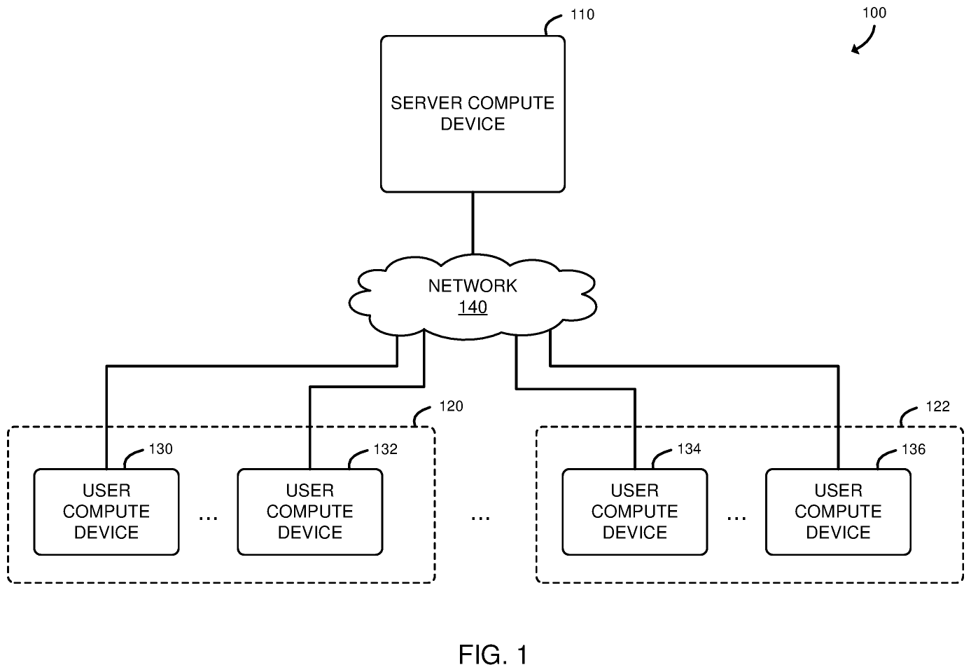

Referring now to FIG. 1, a system 100 for coordinating employee management (e.g., onboarding, training, mentoring, etc.) programs includes, in the illustrative embodiment, a server compute device 110 in communication with user compute devices 130, 132, 134, 136 of multiple organizations 120, 122 (e.g. law enforcement organizations, emergency medical services organizations, correctional facilities, 911 (e.g., emergency) dispatch centers, private security, etc.). In operation, the server compute device 110 provides, to each user compute device 130, 132, 134, 136, a dashboard that is usable to (e.g., provides an interface to enable a user to) coordinate one or more employee management programs. That is, the server compute device 110 may execute more than one employee management program (e.g., to accommodate the needs of the different organizations 120, 122). Further, the server compute device 110, in the illustrative embodiment, provides a different dashboard depending on the role of the user of a given user compute device 130, 132 134, 136. For example, the server compute device 110 may provide a dashboard that enables an administrator or coordinator for an organization (e.g., the organization 120) to modify or create new employee management programs, may provide a different dashboard that enables a trainer or supervisor to enter progress data for one or more trainees (e.g., data indicative of the progress of the trainee(s)) under a corresponding employee management program and view their progress (e.g., in one or more graphs), and may provide yet another dashboard that is customized for use by a trainee, which may allow the trainee to view progress data regarding the trainee (e.g., evaluations submitted by the trainer) and/or provide feedback (e.g., comments, etc.) regarding one or more aspects of the employee management program (e.g., a field training program) that the trainee is enrolled in. The server compute device 110 may provide a dashboard that summarizes data for a single employee management program, a position (e.g., a job type, such as patrol officer) in which multiple employee management programs are summarized, and/or an entire customer (e.g., organization's) site, in which multiple programs and positions may be summarized. Each employee management program may be embodied as one or more structured stages and/or status(es) of a public safety employee (e.g., trainee) that can be utilized for multiple positions/roles within an organization (e.g., an organization 120, 122). While example embodiments of the systems and methods are described herein with reference to supervisors, trainers, trainees, mentors, and mentees, it should be understood that the systems and methods could be applied to any employee management programs in which the people involved in the programs may have roles other than the specific roles used in the examples. Moreover, a user of the system 100 may have multiple concurrent roles (e.g., as both a supervisor or trainer and also a trainee or mentee) rather than a single role. As such, references specific roles of people in this disclosure should be interpreted as illustrative examples rather than limitations on the scope of the disclosure.

A described in more detail herein, the system 100 maintains data (e.g. in a data structure stored by the server compute device 110) defining an employee management program (also referred to herein simply as a “program”) including a name of a stage and/or status associated with a given program. The system 100 (e.g., the server compute device 110) may also provide (e.g., to a user of a corresponding user compute device 130, 132, 134, 136) an option of adding one or more phases or additional stages within a program. In some embodiments, a program may include program-specific forms and/or general forms that can be created with a custom workflow (e.g., by a user interacting with a wizard (e.g., a user interface type that presents a user with a sequence of dialog boxes that lead the user through a series of steps)) to measure performance with performance categories that have a defined ratings scale or custom questions that allow an administrator to obtain specific feedback. Additionally, a program may defined with skills that are tracked by the system 100 (e.g., the server compute device 110) during the performance of an employee's (e.g., trainee's) job in the program.

A program may include one or more activities, such as trainings and/or calls that may be tracked by the system 100 (e.g., the server compute device 110). Further, a program may include one or more courses that can be defined as a requirement to completion of the program (e.g., by an employee/trainee). Similarly, a program may be defined to include one or more quizzes that must be successfully passed (e.g., by an employee) to complete the program. In some embodiments, a program may be defined with one or more tasks that must be completed during the program or a phase of the program (e.g., for an employee to successfully complete the program). In some embodiments, alerts may be defined based on specified (e.g., by an administrator) metrics, time frames may be established for how long an employee should be in a program or phase, and/or settings may be provided (e.g., by an administrator) defining a program that a person (e.g., employee) will be enrolled in next, after successfully completing a given program. In some embodiments, the system 100 (e.g., the server compute device 110) enables users to choose from a template of preconfigured programs with preconfigured options (e.g., courses, phases, activities, tasks, tracked skills, quizzes, alerts, etc.) so as to limit the setup time for a new program. As described in more detail herein, the system 100 may provide detailed reports to display information tracked by the system 100 regarding skills, performance categories, tasks, and other information, for a given program or across multiple programs.

As described in more detail herein, the server compute device 110 may provide other functions through the dashboard as well, including enabling an employee to be matched with and communicate with a mentor (e.g., a person having experience in the role that the trainee is being trained for and that acts as a trusted advisor), enabling a user to select from predefined textual responses in free-form text fields (e.g., to expedite the completion of a form presented on a dashboard), providing a resources area that enables users to share files (e.g., maps of geographic areas, floor plans of buildings, etc.) that are useful in performing their duties (e.g., locating a building or a room within a building where an emergency has occurred), viewing and responding to alerts regarding the progress of personnel (e.g., trainees) in an employee management program (e.g., to take corrective action), viewing schedules, and searching for data stored in association with an employee management program.

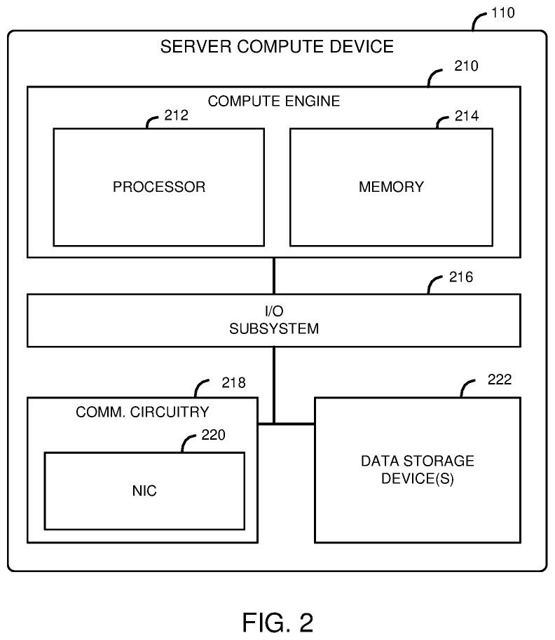

Referring now to FIG. 2, the illustrative server compute device 110 includes a compute engine 210, an input/output (I/O) subsystem 216, communication circuitry 218, and a data storage subsystem 222. Of course, in other embodiments, the server compute device 110 may include other or additional components, such as those commonly found in a computer (e.g., a display, peripheral devices, etc.). Additionally, in some embodiments, one or more of the illustrative components may be incorporated in, or otherwise form a portion of, another component.

The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as accounts of users of the system 100, data defining one or more employee management programs, including forms used in the programs, progress data for trainees, resources (e.g., files) shared among users of the system 100, applications, libraries, and drivers.

The compute engine 210 is communicatively coupled to other components of the server compute device 110 via the I/O subsystem 216, which may be embodied as circuitry and/or components to facilitate input/output operations with the compute engine 210 (e.g., with the processor 212 and the main memory 214) and other components of the server compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the server compute device 110, into the compute engine 210.

The communication circuitry 218 may be embodied as any communication circuit, device, or collection thereof, capable of enabling communications over a network between the server compute device 110 and another device (e.g., the user compute devices 130, 132, 134, 136, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the server compute device 110 to connect with another compute device (e.g., the user compute devices 130, 132, 134, 136, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the server compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems. While shown as a single unit, it should be appreciated that the components of the server compute device 110 may, in some embodiments, be distributed across multiple physical locations (e.g., multiple racks in a data center). Further, one or more of the components may be virtualized (e.g., in a virtual machine executing on one or more physical compute devices).

The user compute devices 130, 132, 134, 136 may have components similar to those described in FIG. 2 with reference to the server compute device 110. The description of those components of the server compute device 110 is equally applicable to the description of components of the user compute devices 130, 132, 134, 136. Further, it should be appreciated that any of the devices 110, 130, 132, 134 136 may include other components, sub-components, and devices commonly found in a computing device, which are not discussed above in reference to the server compute device 110 and not discussed herein for clarity of the description.

In the illustrative embodiment, the server compute device 110 and the user compute devices 130, 132, 134, 136 are in communication via a network 140, which may be embodied as any type of wired or wireless communication network, including global networks (e.g., the internet), local area networks (LANs) or wide area networks (WANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

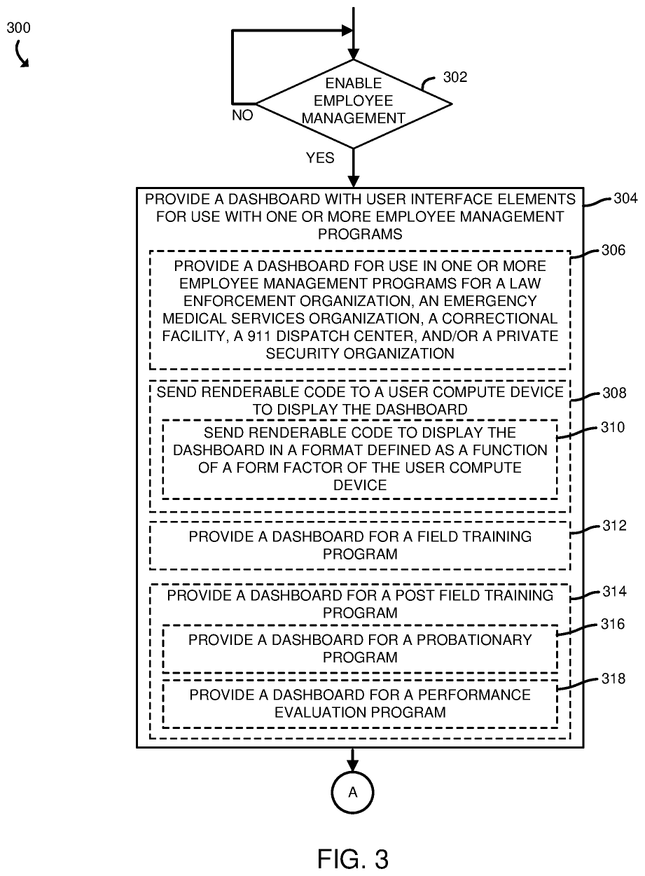

Referring now to FIG. 3, the system 100 (e.g., the server compute device 110 of the system 100), in the illustrative embodiment, may perform a method 300 for coordinating one or more employee management programs. As discussed above, each employee management program may be embodied as one or more structured stages and/or status(es) of a public safety employee that can be utilized for multiple positions/roles within an organization (e.g., an organization 120, 122). The method 300 begins with block 302, in which the system 100 (e.g., the server compute device 110) determines whether to enable employee management (e.g., coordinate one or more employee management programs). In the illustrative embodiment, the server compute device 110 may determine to enable employee management in response to a request from another compute device (e.g., a user compute device 130, 132, 134, 136) to do so, in response to determining that a configuration setting (e.g., in a configuration file in the data storage 222) indicates to enable employee management, and/or based on other factors. Regardless, in response to a determination to enable employee management, the method 300, in the illustrative embodiment, advances to block 304, in which the server compute device 110 provides a dashboard with user interface elements (e.g., buttons, lists, menus, text fields, icons, etc.) for use with one or more employee management programs. In doing so, and as indicated in block 306, the server compute device 110 provides a dashboard for use in one or more employee management programs for a law enforcement organization, an emergency medical services organization, a correctional facility, a 911 dispatch center, a private security organization, and/or other safety-related organization.

As indicated in block 308, the server compute device 110, in providing the dashboard, sends renderable code (e.g., hyper-text markup language (HTML), JavaScript, etc.) to a user compute device 130, 132, 134, 136 (e.g., through the network 140) to display the dashboard. In doing so, and as indicated in block 310, in the illustrative embodiment, the server compute device 110 sends renderable code to display the dashboard in a format defined as a function of (e.g., varying based on) a form factor of the user compute device 130, 132, 134, 136. For example, the dashboard may be rendered differently on a user compute device that is a smart phone (e.g., having a relatively small screen size) rather than a desktop computer, such as by rearranging the positions of components to account for a different amount of horizontal space, hiding elements (e.g., menu items) and showing those hidden elements only upon request (e.g., when a menu icon is selected) rather than showing those elements alongside other user interface elements (e.g., on a desktop version of the dashboard), etc.

As indicated in block 312, the server compute device 110 may provide a dashboard for a field training program. Additionally or alternatively, the server compute device 110 may provide a dashboard for a post-field training program (e.g., an employee management program for managing personnel that have graduated from field training), as indicated in block 314. For example, and as indicated in blocks 316 and 318, the server compute device 110 may provide a dashboard for a probationary program (e.g., a program immediately following field training, in which a person is evaluated with relatively high scrutiny) and/or a dashboard for a performance evaluation program (e.g., a program following the probationary program, in which a person is evaluated with lower scrutiny than in a field training program or a probationary program).

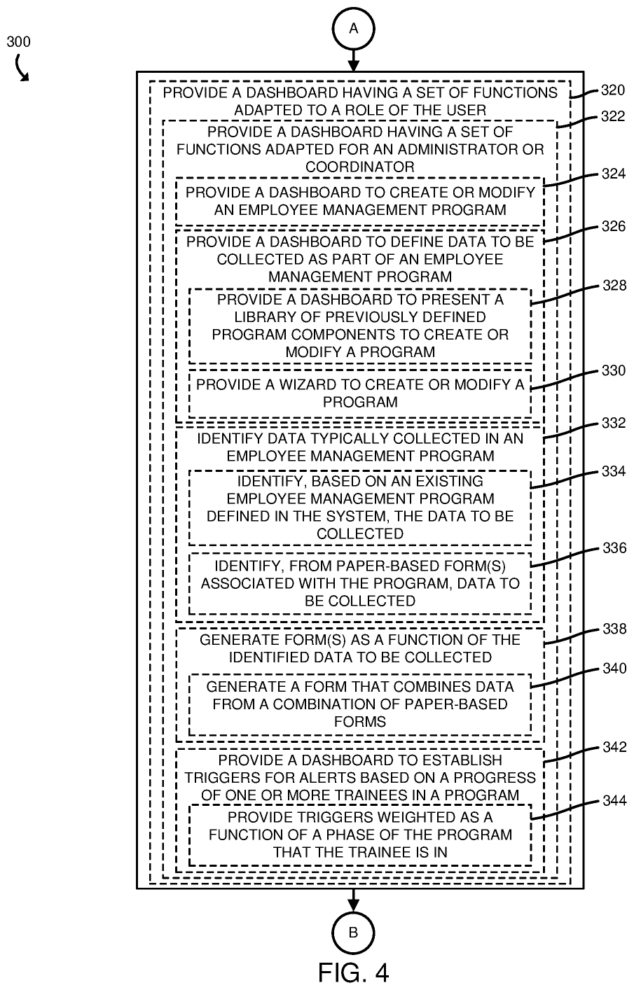

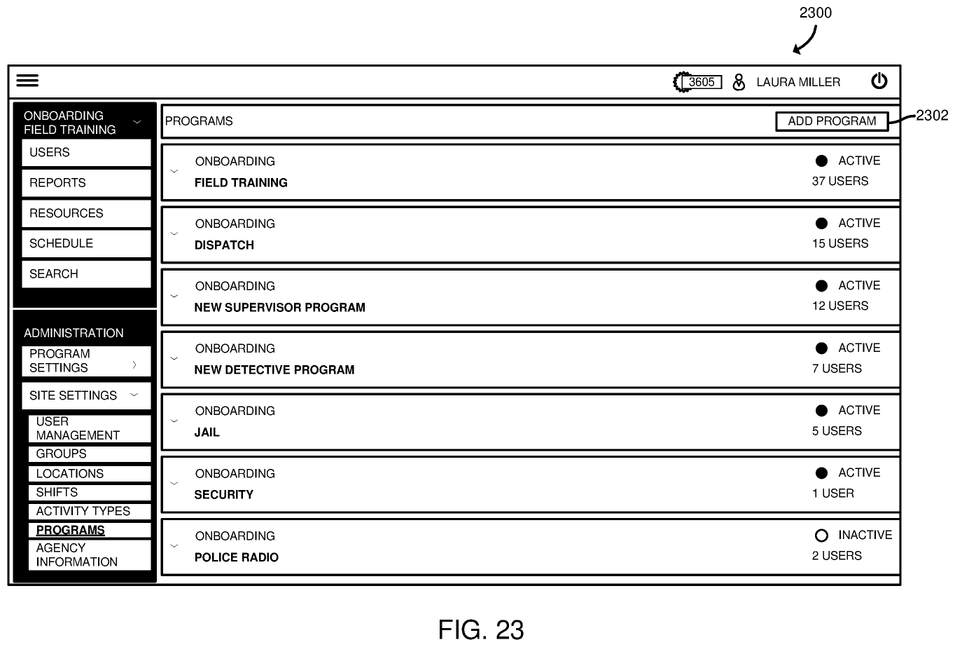

Referring now to FIG. 4, and as indicated in block 320, the server compute device 110 may provide a dashboard having a set of functions adapted to the role of the user (e.g., of the corresponding user compute device 130, 132, 134, 136). For example, and as indicated in block 322, the server compute device 110 may provide a dashboard having a set of functions for an administrator or coordinator. In doing so, and as indicated in block 324, the server compute device 110 may provide a dashboard to create or modify an employee management program (e.g., by selecting a “programs” setting within a “site settings” portion of the dashboard, as shown in FIG. 23). As indicated in block 326, the server compute device 110 may provide a dashboard usable to define data to be collected as part of an employee management program (e.g., allow the user to define a set of questions to be asked in one or more forms that are to be included in the employee management program). As used herein, and unless otherwise specified, the term “form” refers to a user interface (e.g., presented on a display of a compute device) that enables a user to enter and/or access data, such as answers to questions regarding a level of competence that a trainee demonstrated in performing a particular task, and that may correspond with a paper-based form that is typically used in a conventional (e.g., paper-based) employee management program.

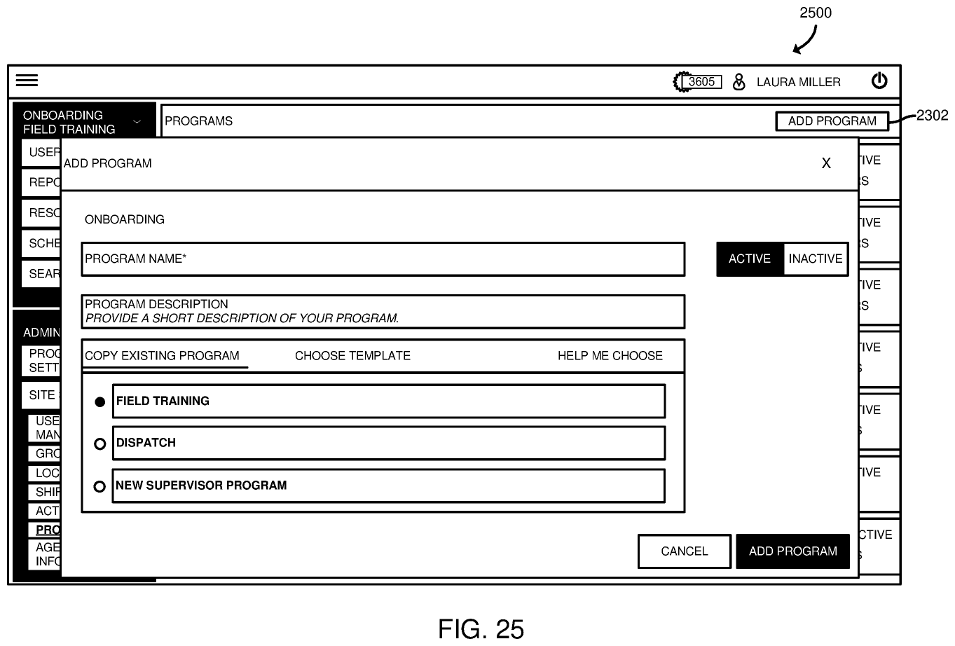

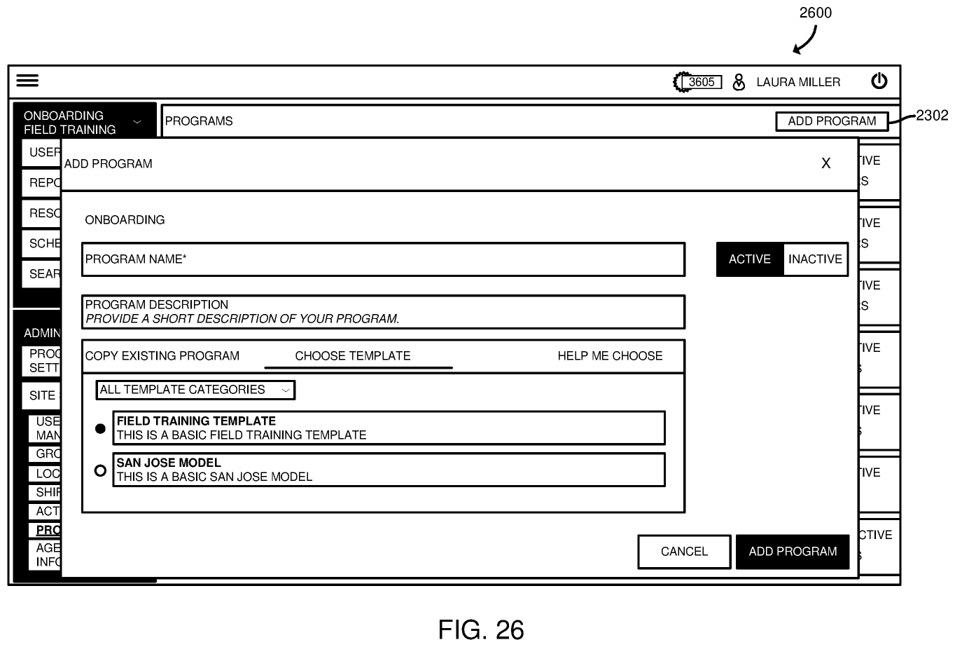

In some embodiments, the server compute device 110 may provide a dashboard to present (e.g., to a user of a user compute device 130, 132, 134, 136) a library of previously defined program components (e.g., skills, activities, tasks, etc.) that can be selected by the user to create or modify an employee management program, as indicated in block 328. The server compute device 110 may provide a wizard (e.g., a user interface type that presents a user with a sequence of dialog boxes that lead the user through a series of steps) to create or modify an employee management program, as indicated in block 330. For example, the server compute device 110 may request that the user indicate the type of position that the employee management program applies to, then iteratively adjust the components of a resulting employee management program based on subsequent questions and user-provided answers regarding the types of information to be collected and tracked under the program. The server compute device 110, as indicated in block 332, may identify data typically collected in an employee management program. For example, the server compute device 110 may identify, based on an existing employee management program defined in the system 100 (e.g., in a data storage device 222), the data to be collected for a new employee management program, as indicated in block 334 (e.g., by copying an existing program, as shown in FIG. 25, or using a template for a program, as shown in FIG. 26). In some embodiments, the server compute device 110 may identify, from one or more paper-based forms associated with an employee management program, the data to be collected (e.g., by analyzing images of the paper-based forms, performing optical character recognition of the images of the paper-based forms to identify the data to be collected, etc.), as indicated in block 336.

The server compute device 110, having identified the data to be collected, may generate one or more forms (e.g., renderable source code defining one or more forms) as a function of the identified data to be collected, as indicated in block 338. Stated differently, the server compute device 110 may generate one or more forms usable to collect the identified data, such as by generating one or more forms that query a user for the data using questions and corresponding text-entry fields, lists to select values from, buttons, or other user interface elements usable to enter data. As indicated in block 340, the server compute device 110 may generate a form that combines data from a combination of paper-based forms (e.g., a many-to-one mapping). The server compute device 110 may provide a dashboard to establish triggers for alerts based on the progress of one or more trainees in a program, as indicated in block 342 (e.g., to generate an alert if a trainee has not demonstrated a requisite degree of competence at a particular task). In doing so, the server compute device 110 may provide a dashboard to establish triggers in which progress data of a trainee is weighted as a function of a phase of the program (e.g., employee management program) that the trainee is in, as indicated in block 344. For example, an alert may be triggered for a trainee who demonstrates a competence of three out of ten in a final phase of a training program, but will not be triggered if the trainee demonstrates that same competence during an initial phase of the training program.

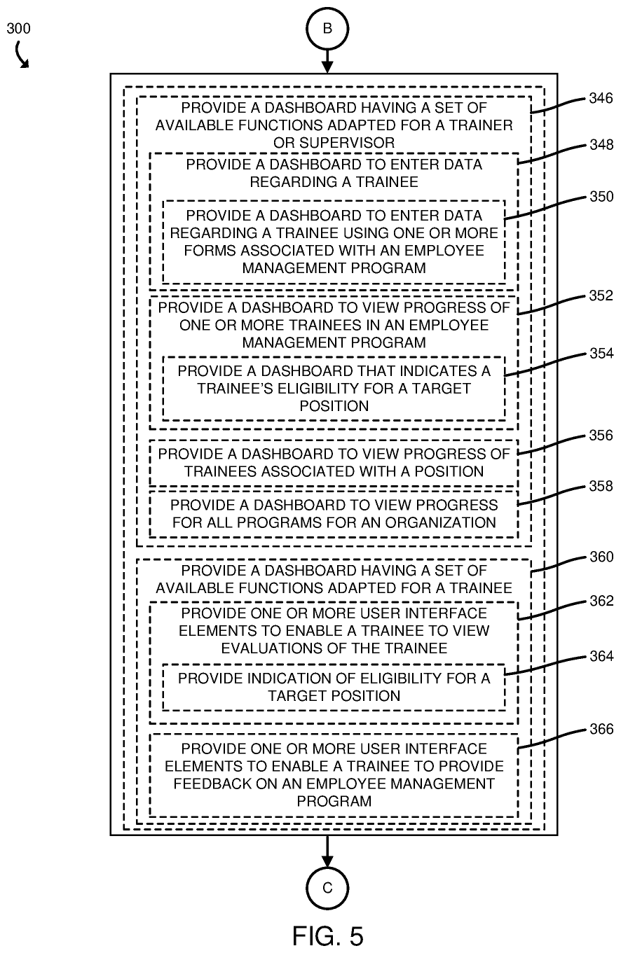

Referring now to FIG. 5, the server compute device 110 may provide a dashboard having a set of available functions adapted for a trainer or supervisor, as indicated in block 346. In doing so, the server compute device 110 may provide a dashboard usable to enter data regarding a trainee, as indicated in block 348. As indicated in block 350, the server compute device 110 may provide a dashboard to enter data regarding a trainee using one or more forms associated with an employee management program (e.g., one or more forms generated using the dashboard for an administrator/coordinator in association with block 338 of FIG. 4). The server compute device 110, in block 352, may provide a dashboard usable to view the progress of one or more trainees in an employee management program (e.g., through visualizations, such as graphs, of one or more trainees' progress over time). In some embodiments, as indicated in block 354, the server compute device 110 may provide a dashboard that indicates a trainee's eligibility for a target position (e.g., a position or job title, such as sergeant, that the trainee is targeting as a goal). For example, the dashboard may include a visual indication (e.g., a progress bar, a numeric value, a color-coded icon, etc.) representative of the trainee's eligibility to be formally considered for the position. In doing so, the server compute device 110 may identify threshold scores required by the corresponding organization to consider a person for a particular position (e.g., based on a historical analysis of the scores of other trainees that have progressed to the position and/or based on threshold scores expressly defined by the organization), perform a comparison of the trainee's scores (e.g., determined as a function of evaluations submitted by trainers in connection with the employee management program) to determine the degree to which the trainee satisfies the threshold scores (e.g., the trainee's score are 96% of the threshold scores), and produce a visual indication of the degree to which the trainee's scores satisfy the threshold scores.

The dashboard, in some embodiments, may also provide a biographical profile of the trainee, such as the trainee's interests, the trainee's personality type (e.g., a Myers-Briggs classification), the trainee's learning style (e.g., visual, hands-on, etc.), and/or related data to provide the trainer or supervisor with contextual information about the trainee. By presenting the contextual information, the server compute device 110 enables the trainer or supervisor to more effectively relate to, communicate with, and train the trainee. In some embodiments, as indicated in block 356, the server compute device 110 may provide a dashboard to enable a user to view the progress of all trainees associated with a specified position (e.g., job title, such as “Patrol Officer”). That is, the server compute device 110 may retrieve and summarize progress data from potentially multiple programs in which trainees having the specified position (e.g., “Patrol Officer”) are enrolled in one or more employee management programs associated with the organization (e.g., the organization 120) and provide a summary of the progress of the trainees across the programs. By providing such a view, the server compute device 110 eliminates the need for the user to individually review the progress of trainees associated with the position on a program by program basis (e.g., viewing a dashboard associated with each employee management program in which trainees having the specified position are enrolled and manually summarizing their overall progress). Further, and as indicated in block 358, the server compute device 110 may provide a dashboard to view progress information for all employee management programs associated with an organization (e.g., the organization 120), without respect to a given position. That is, the server compute device 110 may provide a dashboard that covers a multitude of employee management programs (e.g., all of the employee management programs associated with the organization 110) and that is not limited to progress information pertaining to a particular position.

The server compute device 110 may also provide a dashboard having a set of available functions adapted for a trainee, as indicated in block 360. In doing so, and as indicated in block 362, the server compute device 110 may provide one or more user interface elements to enable a trainee to view evaluations of the trainee (e.g., one or more forms completed by a trainer/supervisor of the trainee, in a read-only mode). In some embodiments, and as indicated in block 364, the server compute device 110 may provide an indication (e.g., a visual indication, such as a progress bar, a numeric value, a color-coded icon, etc.) representative of the trainee's eligibility to be formally considered for a target position (e.g., a position or job title, such as sergeant, that the trainee is targeting as a goal). In doing so, and as described above, the server compute device 110 may identify threshold scores required by the corresponding organization to consider a person for a particular position (e.g., based on a historical analysis of the scores of other trainees that have progressed to the position and/or based on threshold scores expressly defined by the organization), perform a comparison of the trainee's scores (e.g., determined as a function of evaluations submitted by trainers in connection with the employee management program) to determine the degree to which the trainee satisfies the threshold scores, and produce a visual indication of the degree to which the trainee's scores satisfy the threshold scores. As indicated in block 366, the server compute device 110 may provide one or more user interface elements to enable a trainee to provide feedback on an employee management program (e.g., a text box to enable the trainee to enter comments or concerns regarding an aspect of a training program, such as comments on a trainer's evaluation of the trainee). The dashboard may also enable the trainee to provide other information to the server compute device 110, such as biographical profile information about the trainee, such as the trainee's interests, personality type, and learning style. In some embodiments, the server compute device 110 may provide information or links to information or tests (e.g., a Myers-Briggs test) to enable the trainee to determine their personality type and/or learning style. The dashboard may additionally enable the trainee to provide information about their goals, such as a position (a job title, job role, etc.) the trainee would like to reach (a “target position”), skills that the trainee would like to be proficient in, etc.

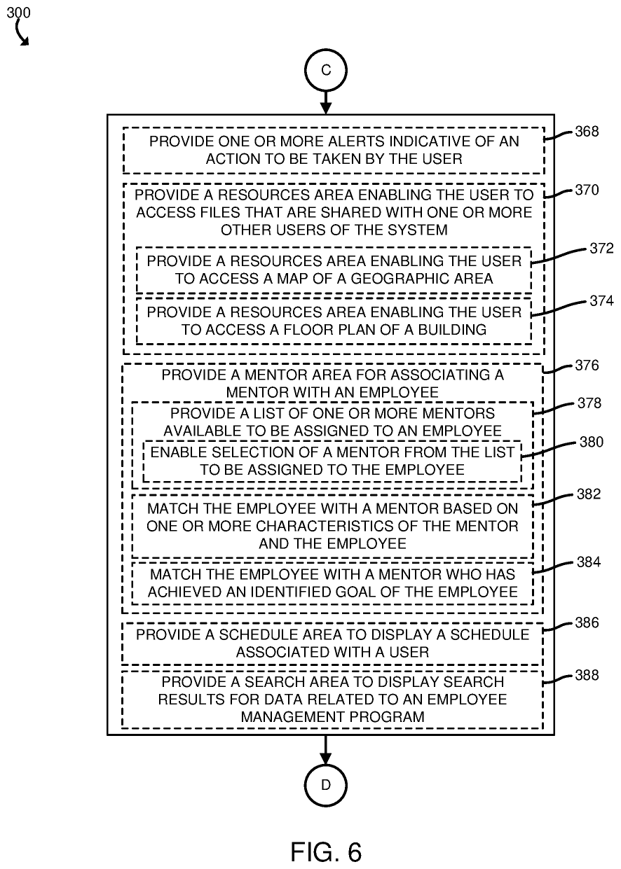

Referring now to FIG. 6, the server compute device 110, may additionally provide (e.g., in the dashboard) one or more alerts (e.g., visual notification(s)) indicative of an action to be taken by the user (e.g., of a user compute device 130, 132, 134, 136), as indicated in block 368. The server compute device 110, in some embodiments, may provide a resources area (e.g., accessible within the dashboard) that enables a user to access files that are shared with one or more other users of the system 100 (e.g., among trainees in the same employee management program coordinated by the system 100), as indicated in block 370. For example, the server compute device 110 may provide a resources area that enables a user to access a map of a geographic area or a floor plan of a building, as indicated in blocks 372 and 374. Such resources may enable personnel to more effectively perform their jobs, such as locating a particular room in a building in which an emergency is taking place.

The server compute device 110 may additionally provide a mentor area (e.g., accessible within the dashboard) for associating a mentor with an employee, as indicated in block 376. As indicated in block 378, the server compute device 110 may provide a list of one or more mentors available to be assigned to an employee. Further, and as indicated in block 380, the server compute device 110 may enable selection of a mentor from the list to be assigned to the employee. As indicated in block 382, the server compute device 110 may match the employee with a mentor based on one or more characteristics of the mentor and the employee. For example, the server compute device 110 may analyze data indicative of a personality type (e.g., a Myers-Briggs indicator) of each available mentor and a given employee and match a mentor with an employee (e.g., based on predefined data indicative of personality types that are known to be compatible). Additionally or alternatively, the server compute device 110 may match a mentor with an employee based on geographic locations of the mentor and the mentee (e.g., preferring smaller geographic distances between the mentor and employee to facilitate potential in-person meetings), similarities in roles (e.g., preferring a mentor with a role that provided the mentor with experiences that the employee may be presently experiencing), and/or based on other characteristics of the mentor and employee. In some embodiments, as indicated in block 384, the server compute device 110 may match the employee with a mentor who has achieved an identified goal of the employee (e.g., a goal identified by the employee, through a corresponding user interface provided by the server compute device 110). For example, the server compute device 110 may determine that the employee has identified a goal of reaching a particular position within the organization (e.g., sergeant) and, in response, the server compute device 110 may identify, as a mentor, a person who has reached that position and/or has previously served as a mentor for other people who have reached that position. In some embodiments, the system 100 may match people (e.g., an employee with another person) for other types of relationships (supervisor/supervisee, trainer/trainee, etc.) using an analysis similar to that described above. The server compute device 110 may also provide a schedule area (e.g., accessible within the dashboard) to display a schedule associated with a user, as indicated in block 386. As indicated in block 388, the server compute device 110 may additionally provide a search area to display search results for data related to an employee management program (e.g., to receive a query and provide search results in response to the query).

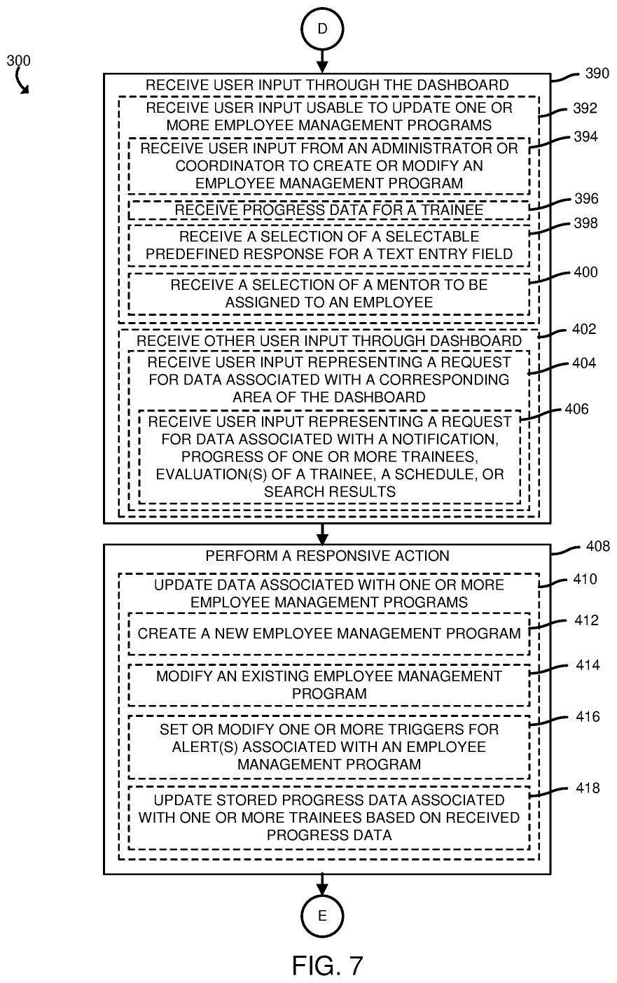

Referring now to FIG. 7, and as indicated in block 390, the server compute device 110 may receive user input through the dashboard. For example, and as indicated in block 392, the server compute device 110 may receive user input that is usable to update one or more employee management programs. In doing so, the server compute device 110 may receive user input from an administrator or coordinator to create or modify an employee management program (e.g., data defining one or more forms to be used in the program, stages of the program, triggers to be established in the program, etc.), as indicated in block 394. In doing so, the server compute device 110 may receive user input through a wizard and/or selections of program components from one or more libraries of previously defined program components to create or modify an employee management program.

As indicated in block 396, the server compute device 110 may receive progress data associated with a trainee (e.g., a set of answers to questions on a form, completed by a trainer/supervisor of a trainee, indicating the trainee's level of competence with regard to a particular task observed by the trainer/supervisor). In receiving the user input, the server compute device 110 may receive a selection of a selectable predefined response for a text entry field presented on the dashboard, as indicated in block 398. That is, the dashboard may provide a set of possible textual answers to select from that, if selected, would populate an otherwise free-form text field in which any text could be entered. By doing so, the system 100 may more efficiently analyze data entered into such fields (e.g., by grouping responses into predefined categories). In other embodiments, the system 100 (e.g., the server compute device 110) may perform natural language processing on received textual responses to determine their meaning. The server compute device 110 may additionally or alternatively receive a selection of a mentor to be assigned to an employee (e.g., a selection from the list provided in block 378), as indicated in block 400. Additionally or alternatively, the server compute device 110 may receive other user input through the dashboard, as indicated in block 402. For example, and as indicated in block 404, the server compute device 110 may receive user input representing a request for data associated with a corresponding area of the dashboard. In doing so, the server compute device 110 may receive user input representing a request for data associated with a notification (e.g., an alert), progress of one or more trainees, evaluation(s) of a trainee, a schedule, or search results (e.g., based on a query provided by the user), as indicated in block 406.

Subsequently, the method 300 advances to block 408, in which the server compute device 110 performs a responsive action (e.g., in response to the received user input). In performing a responsive action, the server compute device 110 may update data associated with one or more employee management programs, as indicated in block 410. In doing so, the server compute device 110 may create a new employee management program, as indicated in block 412, or may modify an existing employee management program (e.g., by changing a form, adding a form, adding a phase to the program, etc.), as indicated in block 414. The server compute device 110 may also set or modify one or more triggers for alert(s) associated with an employee management program, as indicated in block 416. The server compute device 110 may also update stored progress data associated with one or more trainees based on received progress data (from a trainer/supervisor), as indicated in block 418.

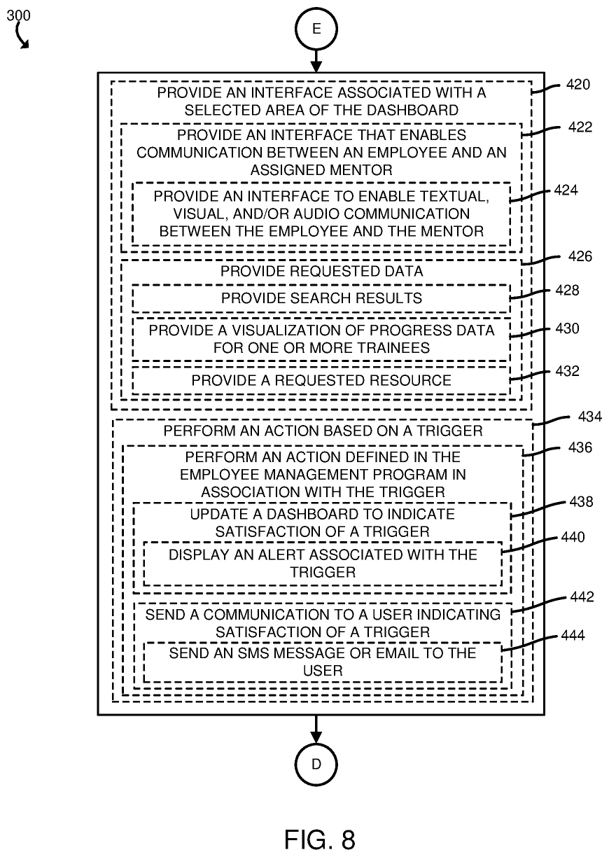

Referring now to FIG. 8, as indicated in block 420, the server compute device 110 may provide an interface associated with a selected area of the dashboard (e.g., an area selected by a user). For example, and as indicated in block 422, the server compute device 110 may provide an interface that enables communication between an employee and an assigned mentor. In doing so, the server compute device 110 may provide an interface (e.g., a user interface) that enables textual, visual, and/or audio communication between the employee and the mentor (e.g., communication using textual messages, video conferencing, etc.), as indicated in block 424. The server compute device 110 may, in block 426, provide requested data as a responsive action. For example, in block 428, the server compute device 110 may provide a set of search results (e.g., in response to a search query received in block 406 of FIG. 7). As indicated in block 430, the server compute device 110 may provide a visualization (e.g., a graph) of progress data for one or more trainees. In some embodiments, the server compute device 110 may provide a requested resource (e.g., a file shared among multiple users in a resources area of the dashboard), as indicated in block 432.

Still referring to FIG. 8, the server compute device 110 may perform an action based on a trigger, as indicated in block 434. For example, and as indicated in block 436, the server compute device 110 may perform an action defined in the employee management program in association with the trigger. In doing so, the server compute device 110 may update a dashboard to indicate satisfaction of a trigger (e.g., satisfaction of one or more criteria defined in association with the trigger, such as a particular progress of a trainee being equal to or less than a defined level of competence at a particular phase of a training program), as indicated in block 438. For example, the server compute device 110 may display an alert (e.g., a notification) associated with the trigger (e.g., on a dashboard provided to a user), as indicated in block 440. The server compute device 110 may additionally or alternatively send a communication to a user (e.g., other than the source code defining the visual appearance of the alert on the dashboard) to indicate satisfaction of the trigger, as indicated in block 442. For example, the server compute device 110 may send a short message service (SMS) message or an email to the user indicating satisfaction of the trigger, as indicated in block 444. Subsequently, the method 300 loops back to block 390 of FIG. 7, in which the server compute device 110 may receive additional user input through the dashboard (e.g., a dashboard provided to any of the user compute devices 130, 132, 134, 136 communicating with the server compute device 110). While the operations of the method 300 are shown in a particular order in FIGS. 3-8, it should be understood that, in some embodiments, the operations could be performed in a different order or concurrently (e.g., receiving user input from one or more users while providing responsive action(s) for one or more other users).

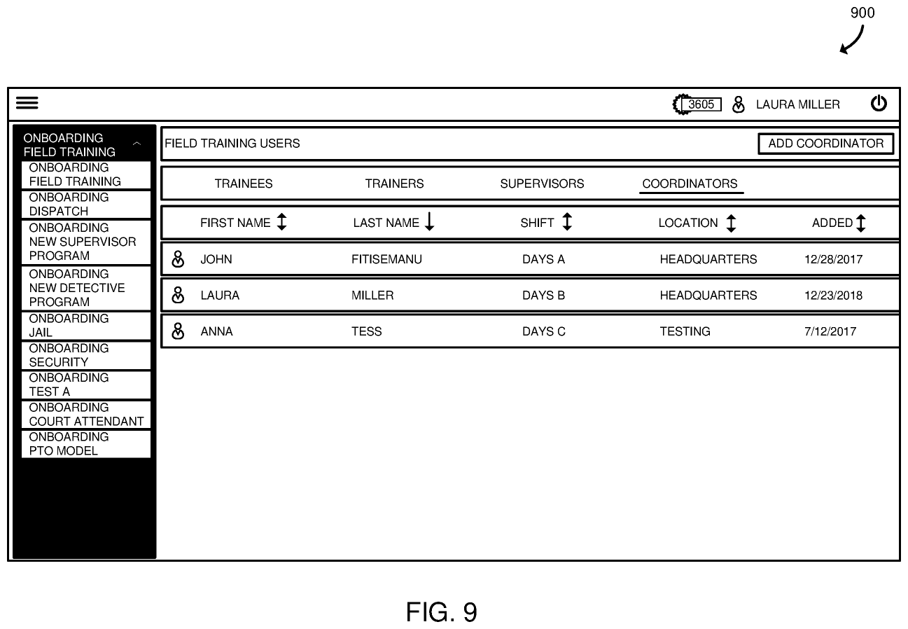

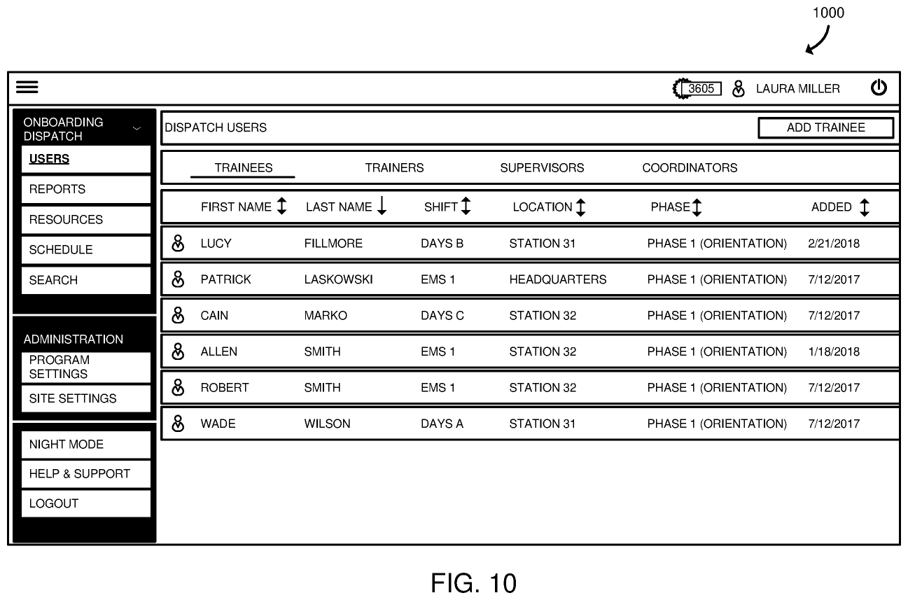

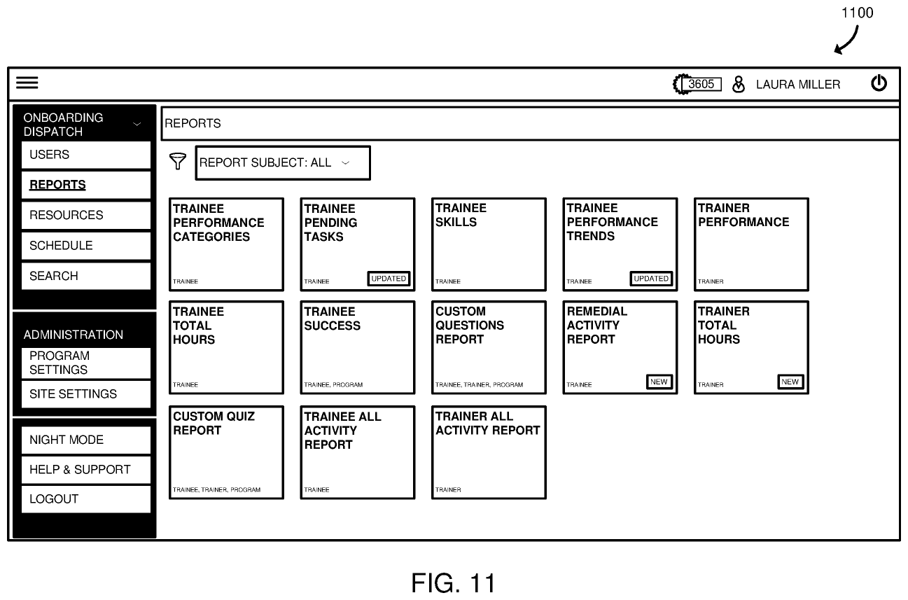

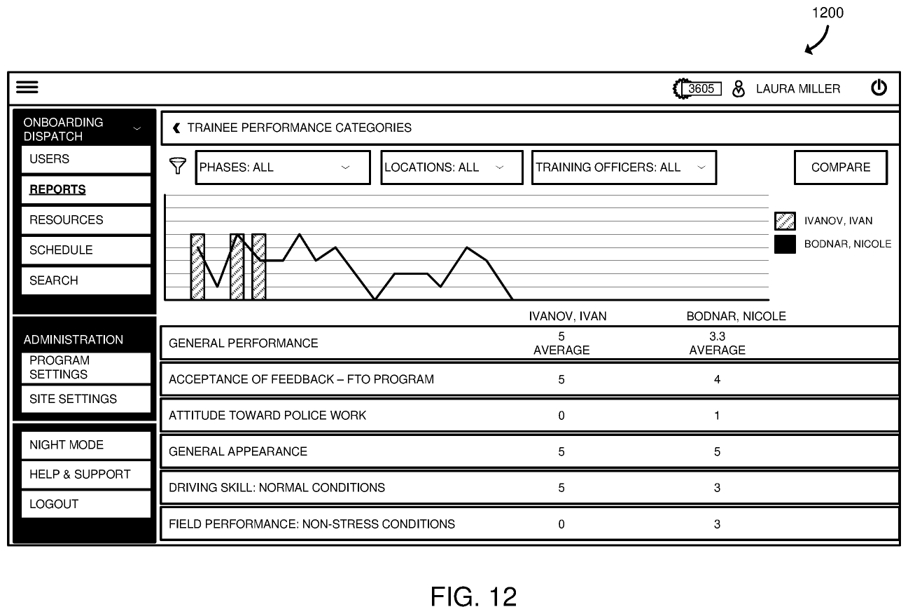

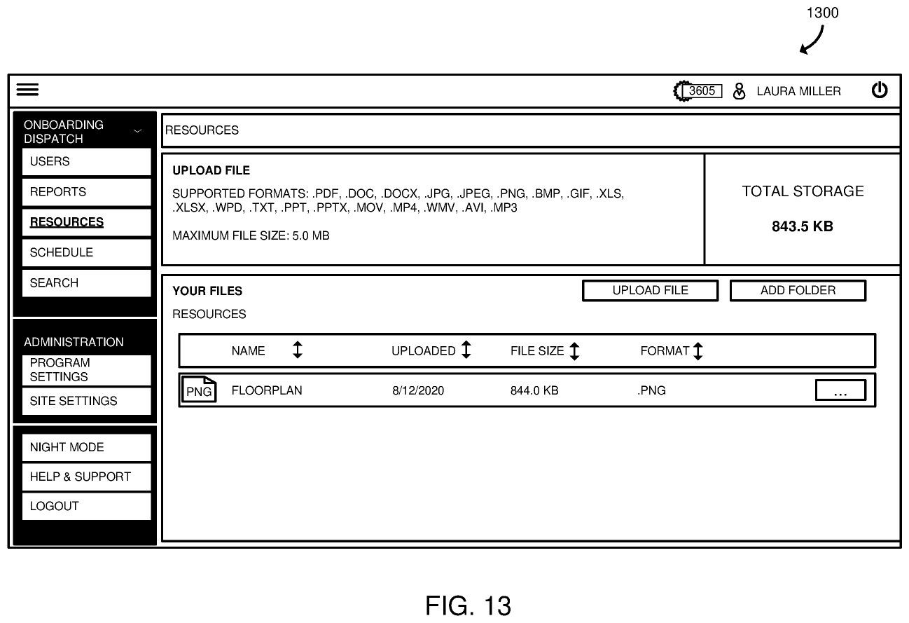

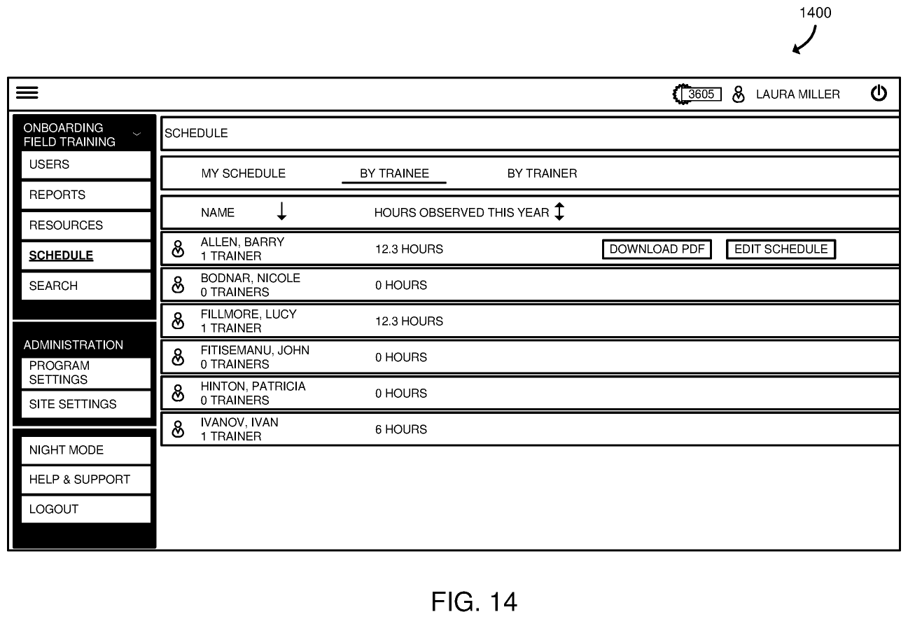

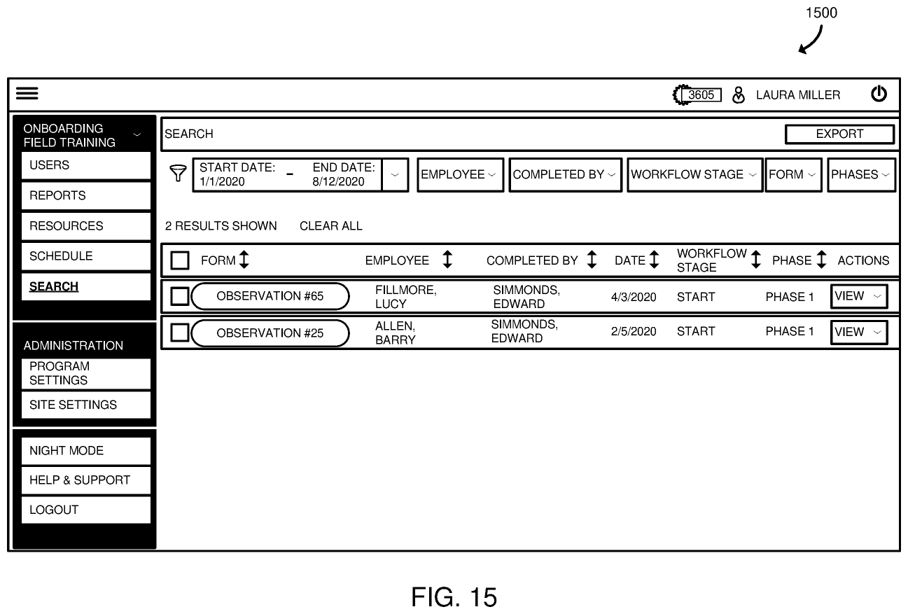

Referring now to FIG. 9, a dashboard (e.g., user interface) 900 for use by an administrator or coordinator enables selection of an employee management program (e.g., a field training, dispatch, new supervisor program, new detective program, jail, security, a test program court attendant, or PTO model). In FIG. 10, a dashboard (e.g., user interface) 1000 for use by an administrator or coordinator displays a list of users in an employee management program (e.g., dispatch). As shown in the dashboard, the users are organized under four selectable categories: trainees, trainers, supervisors, and coordinators. Referring to FIG. 11, a dashboard (e.g., user interface) 1100 for displaying selectable reports (e.g., trainee performance categories, trainee pending tasks, trainee skills, trainee performance trends, trainer performance, trainee total hours, trainee success, custom questions report, remedial activity report, trainer total hours, custom quiz report, trainee all activity report, trainer all activity report) associated with an employee management program is shown. FIG. 12 includes a dashboard 1200 showing a report with a comparison of the progress of two trainees in a program (e.g., dispatch). Referring now to FIG. 13, a dashboard 1300 includes a resources area with resources (e.g., one or more files) available to users of the system 100. In the dashboard 1300, a file with a floorplan of a building is available to the user. Referring briefly to FIG. 14, a dashboard 1400 with schedule information associated with several users of the system 100 (e.g., trainees enrolled in a field training program) is shown, including the name of each trainee, the number of trainers associated with each trainee, and the number of hours observed for each trainee. In FIG. 15, a dashboard 1500 includes components for entering search parameters (e.g., start date, end date, employee, completed by, workflow stage, form, phases). The dashboard 1500 also includes a set of corresponding search results based on data associated with a given employee management program (e.g., field training) and the search parameters.

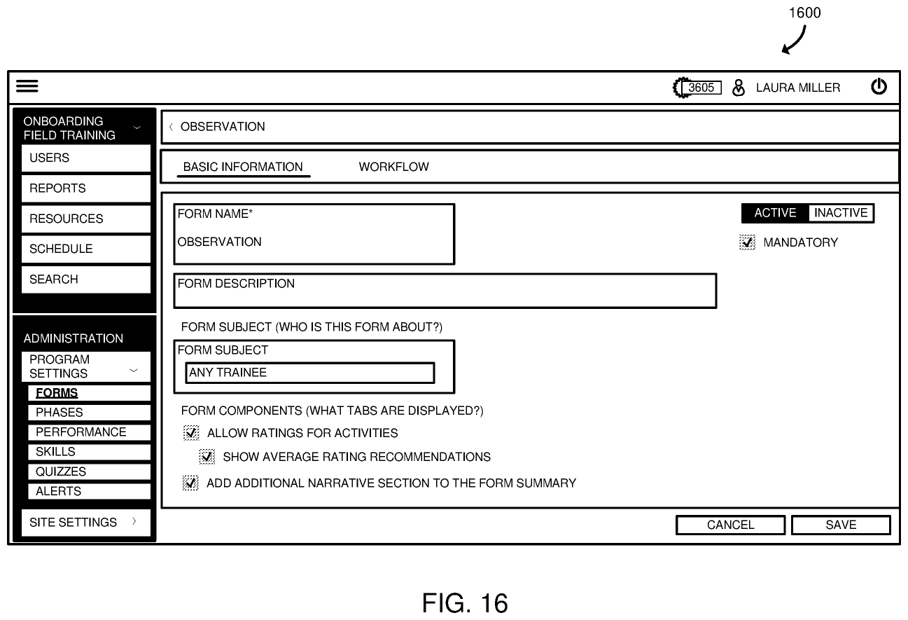

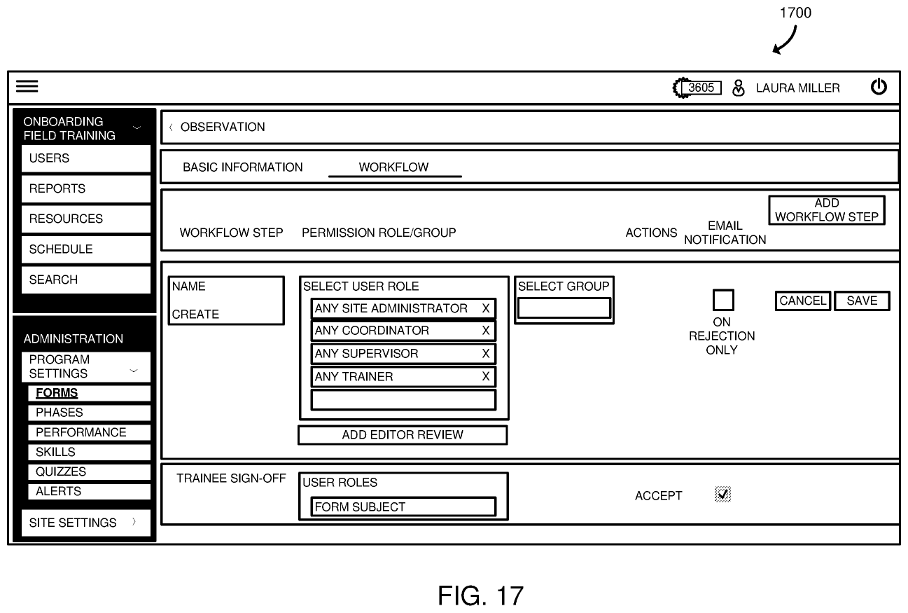

Referring now to FIG. 16, a dashboard 1600 for editing settings associated with an employee management program (e.g., field training) includes user interface elements for editing a form included in the employee management program. As shown, the dashboard 1600 enables the user (e.g., administrator) to enter a name for the form, a description of the form, a subject of the form, and select other sections to be included in the form (e.g., tabs). Turning to FIG. 17, a dashboard 1700 enables a user (e.g., administrator) to edit a workflow associated with a form (e.g., the observation form associated with FIG. 16).

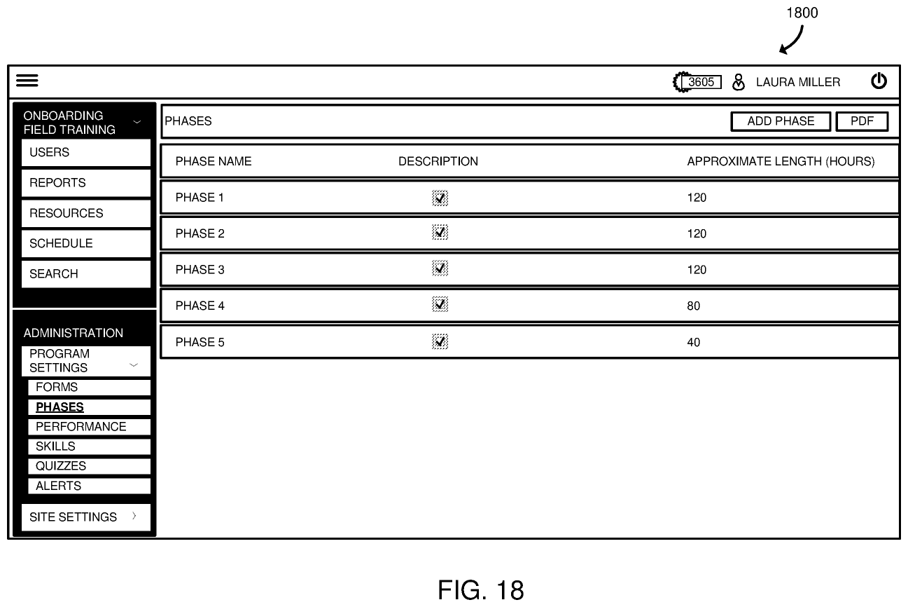

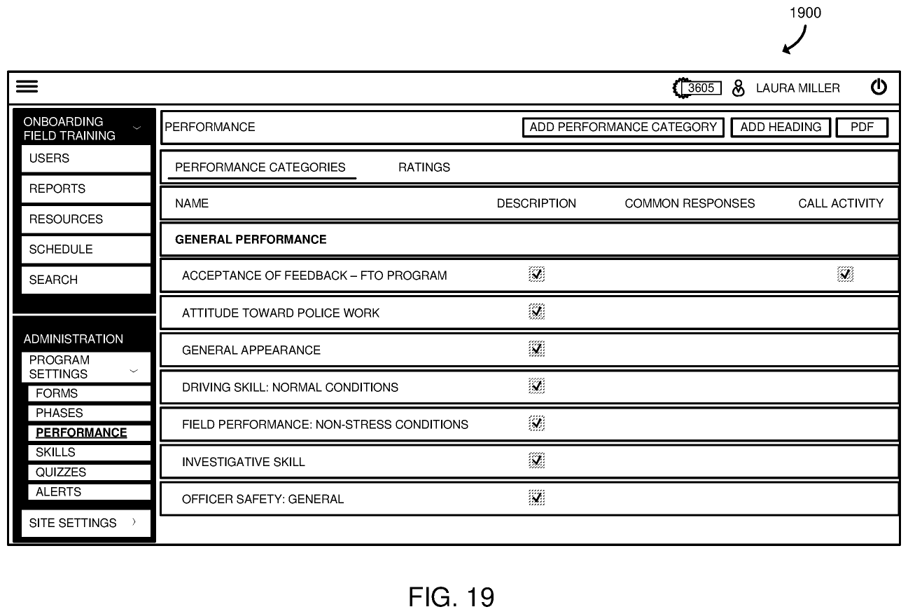

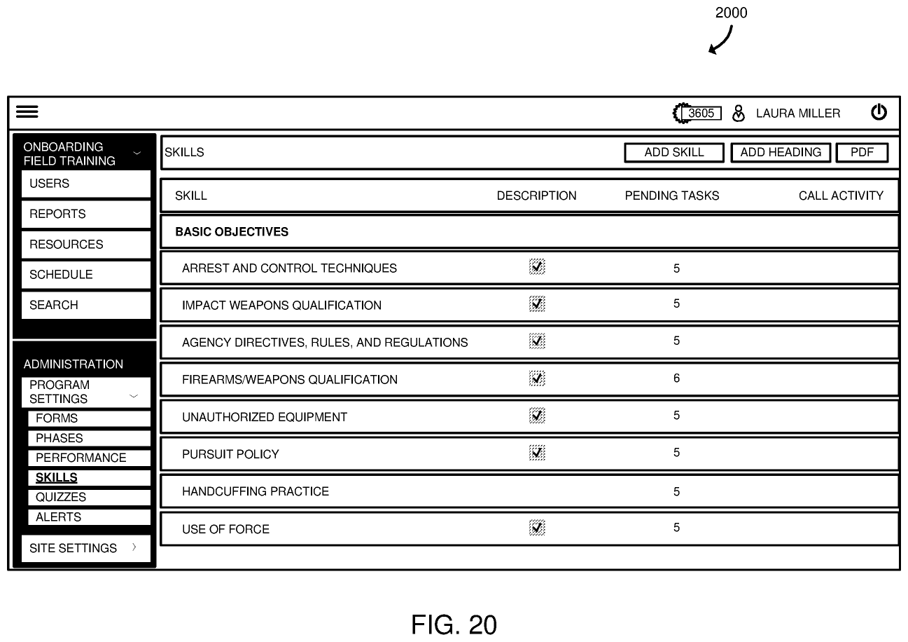

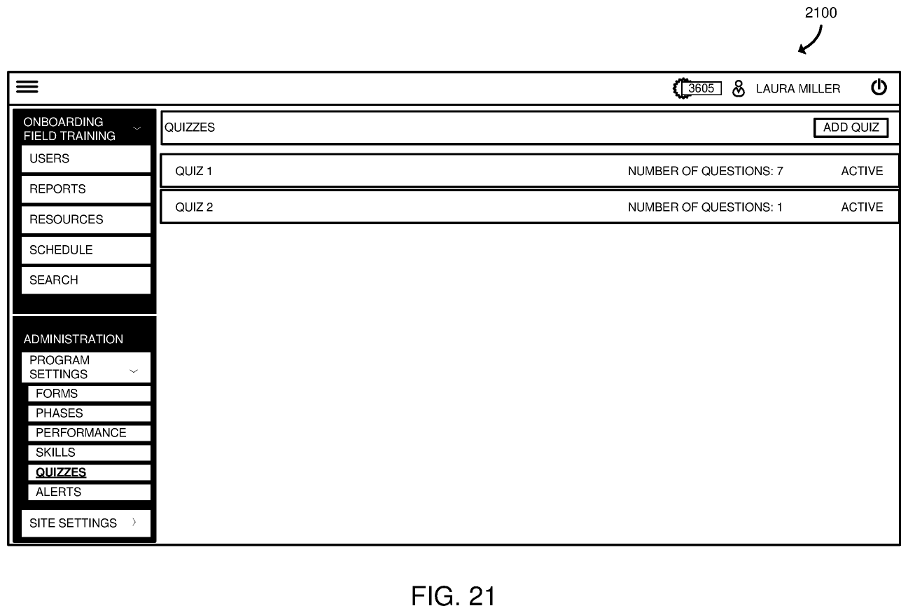

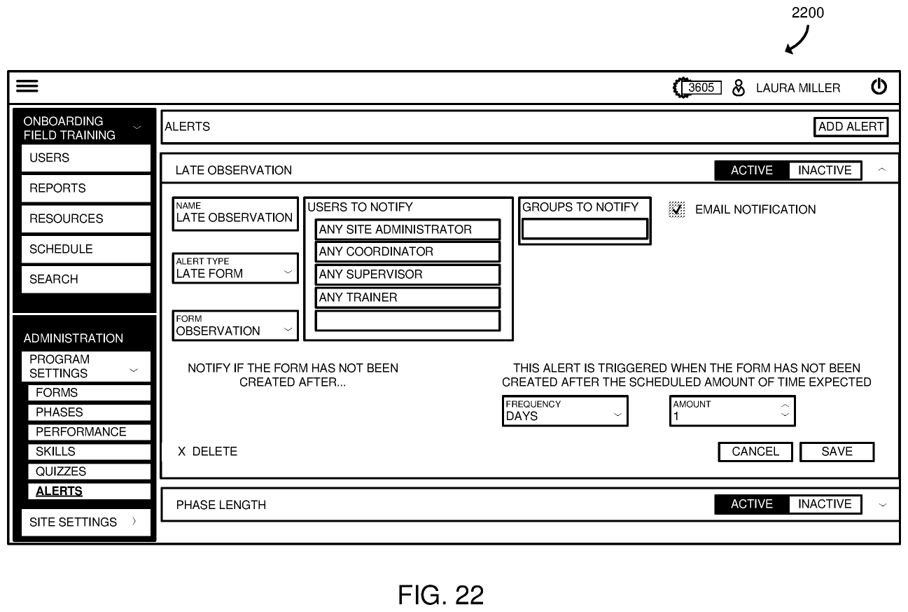

In FIG. 18, a dashboard 1800 enables a user (e.g., administrator) to view phases of a program (e.g., field training), including an approximate number of hours included in each phase. Referring now to FIG. 19, a dashboard 1900 provides a set of performance categories to be included in a program (e.g., field training). The set of performance categories may be modified by a user (e.g., administrator), such as by adding one or more additional performance categories. In some embodiments, when a user takes a call or performs another kind of training activity, the server compute device 100 provides the ability to tie the training activity to a performance category and grade it or tie it to a skill. If a user chooses a performance category and grades it, once that grade is done, it carries over to a performance section (e.g., a performance tab) and offers a “recommendation” for that category based on all the scores in the activities. In FIG. 20, a dashboard 2000 provided to a user (e.g., administrator) enables viewing and editing of a set of skills to be assessed in an employee management program (e.g., field training). Referring to FIG. 21, a dashboard 2100 presents a set of quizzes to be administered to trainees in an employee management program (e.g., field training). As shown, the set of quizzes may be modified, such as by adding one or more additional quizzes to the program. In FIG. 22, a dashboard 2200 enables a user (e.g., administrator) to define triggers (e.g., one or more conditions to be met) for one or more alerts. Additionally, the dashboard 2200 enables the user to define how an alert will be communicated to a user (e.g., whether an email notification regarding the alert will be sent).

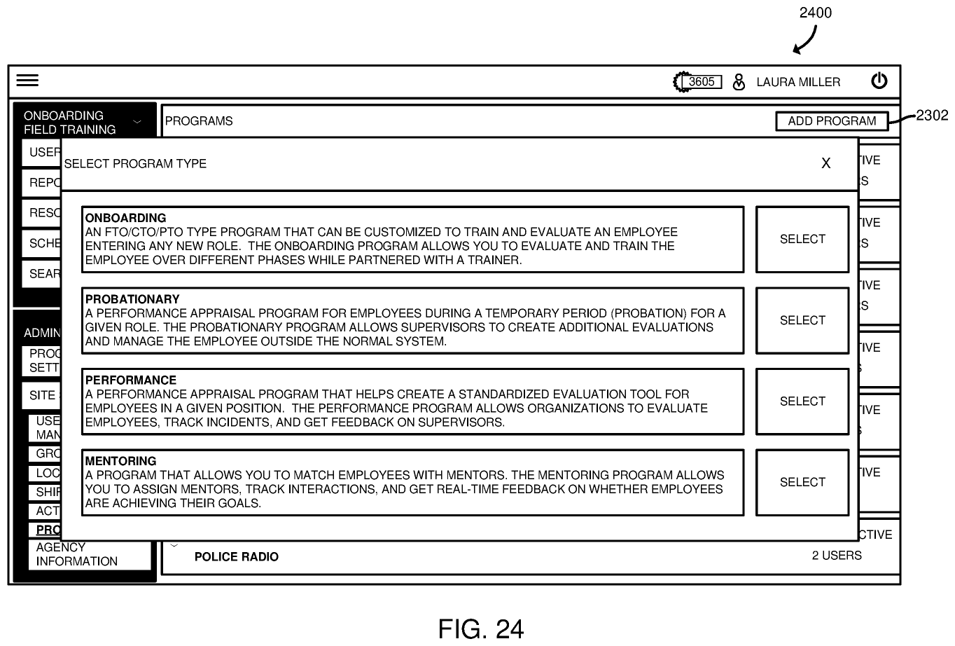

Referring now to FIG. 23, a dashboard 2300 presents site settings, including a list of employee management programs and corresponding details (e.g., active or non-active, number of users). Additionally, a program may be added (e.g., created) when a user selects an “ADD PROGRAM” button 2302. Subsequently, a user may select a program type, as shown in the dashboard 2400 in FIG. 24. After selecting a program type, the user may create (e.g., add) a program by copying an existing program, as shown in the dashboard 2500 in FIG. 25 or may create a program from a template, as shown in the dashboard 2600 in FIG. 26.

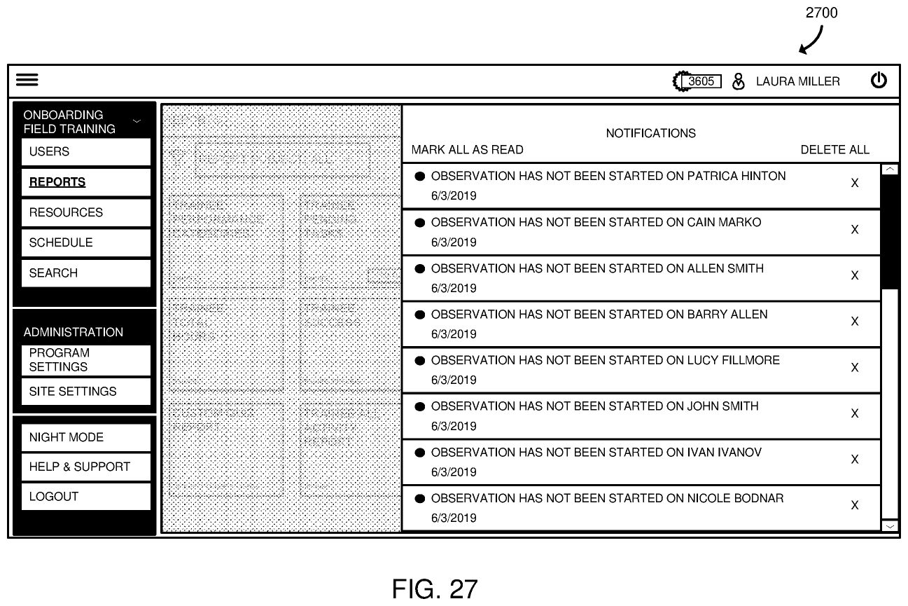

In FIG. 27, a dashboard 2700 with a set of notifications (e.g., indicative of alerts that have been triggered) is shown. In the illustrative embodiment, the set of notifications is displayed in response to selection of a corresponding icon that is representative of the number of notifications available to be viewed by the user. As shown, the set of notifications overlays other user interface elements and those overlaid user interface elements may be greyed out (e.g., to improve visibility of the notifications).

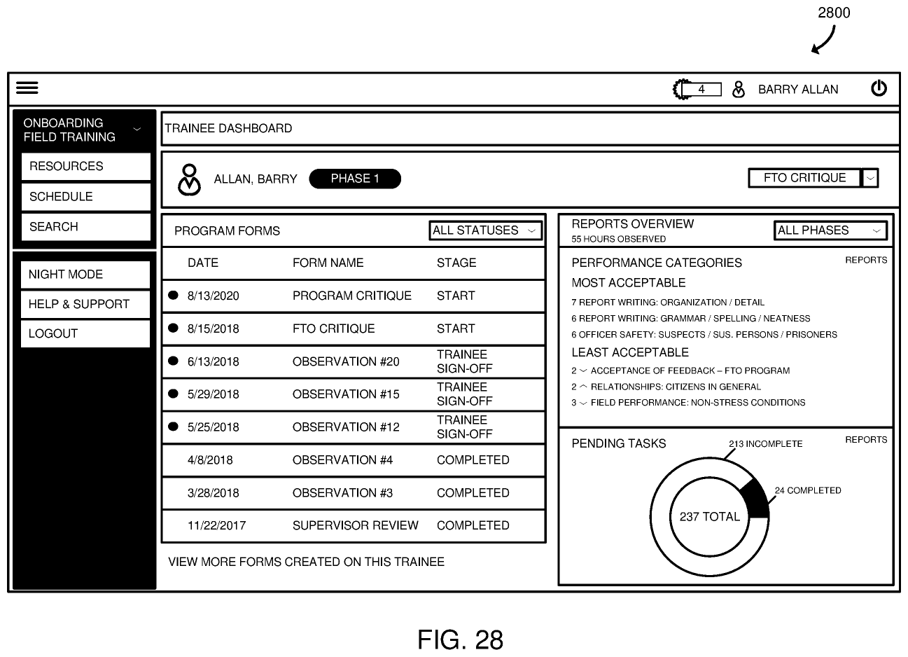

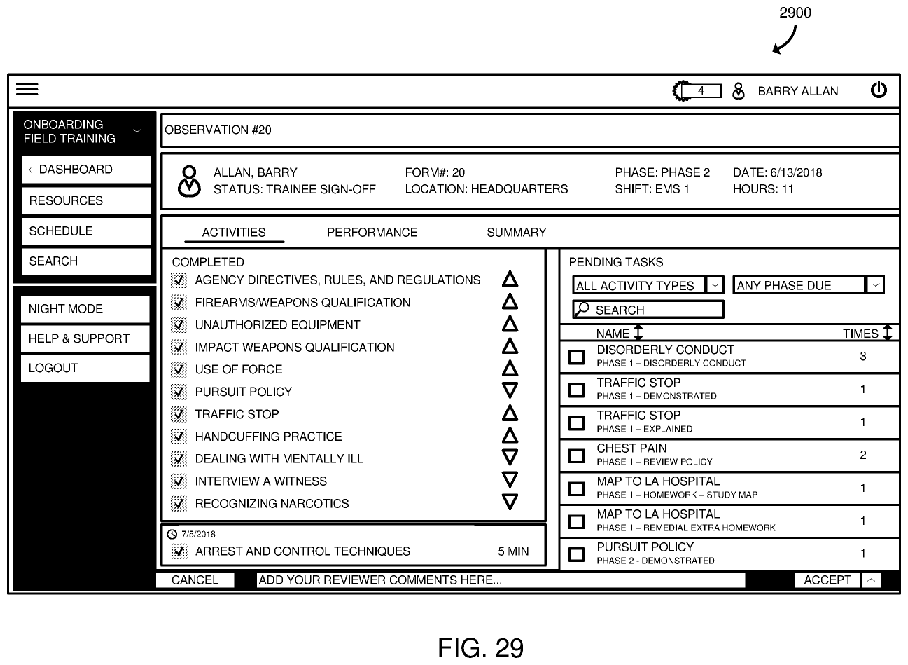

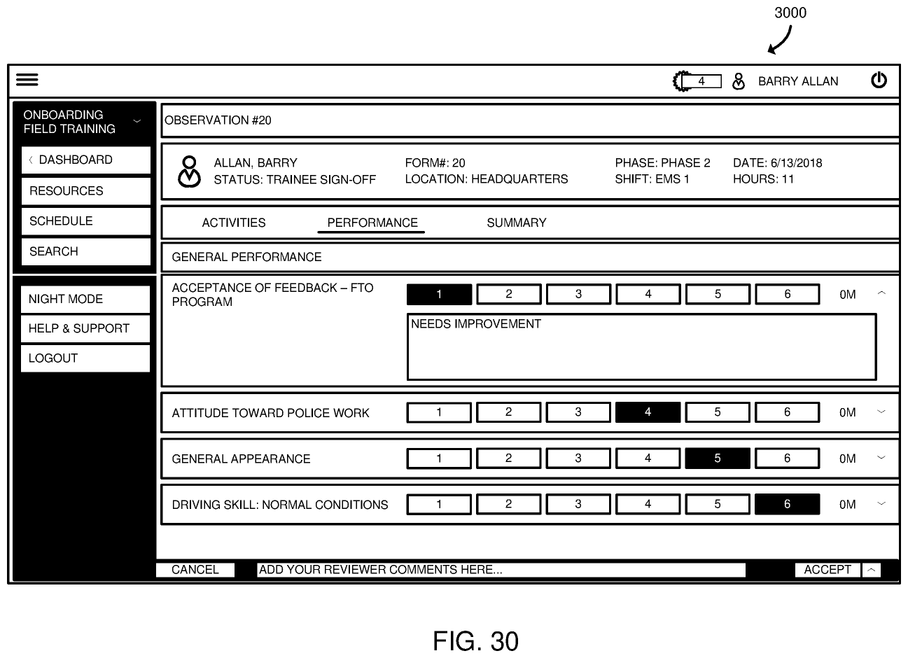

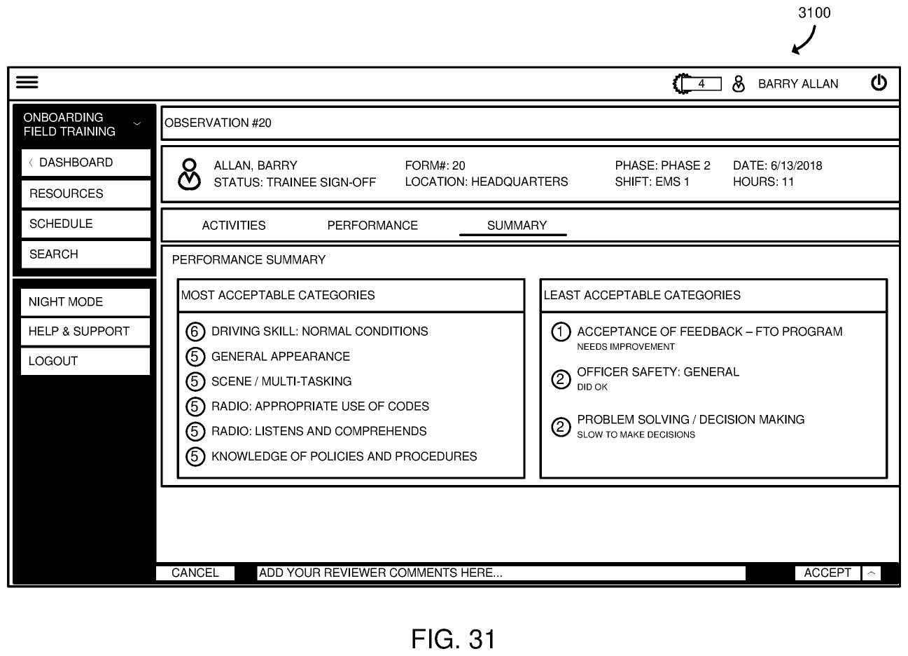

Referring now to FIG. 28, a dashboard 2800 for a trainee includes a listing of program forms associated with the trainee and the status of each form, a section listing the best performance categories and worst performance categories of the trainee, and a graphical representation of the number of tasks associated with the trainee, including a total number of tasks, the number of completed tasks, and the number of incomplete tasks. In FIG. 29, a dashboard 2900 for a trainee illustratively includes an activities section displaying a list of completed activities and pending tasks associated with the trainee. Referring to FIG. 30, a dashboard 3000 for a trainee includes performance information associated with the trainee (e.g., based on information entered by a trainer or supervisor using one or more forms associated with the corresponding employee management program). In FIG. 31, a dashboard 3100 for a trainee includes a summary of the performance of the trainee, including a set of the highest rated skills and the lowest rated skills of the trainee. In each of the dashboards 2900, 3000, 3100, a section enables the user (e.g., trainee) to enter comments on the information displayed in the corresponding dashboard 2900, 3000, 3100.

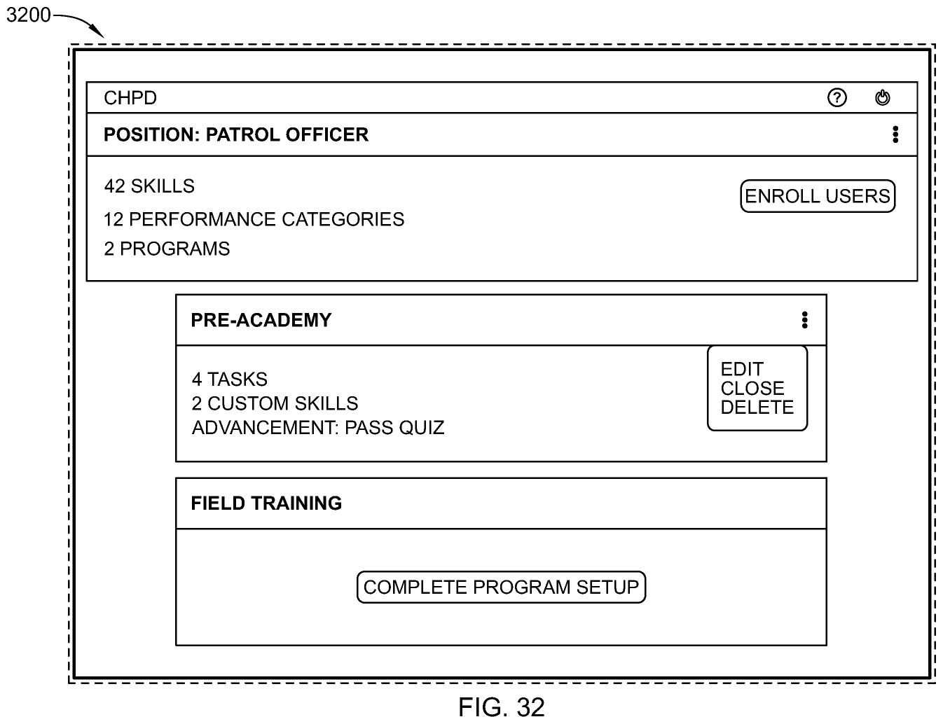

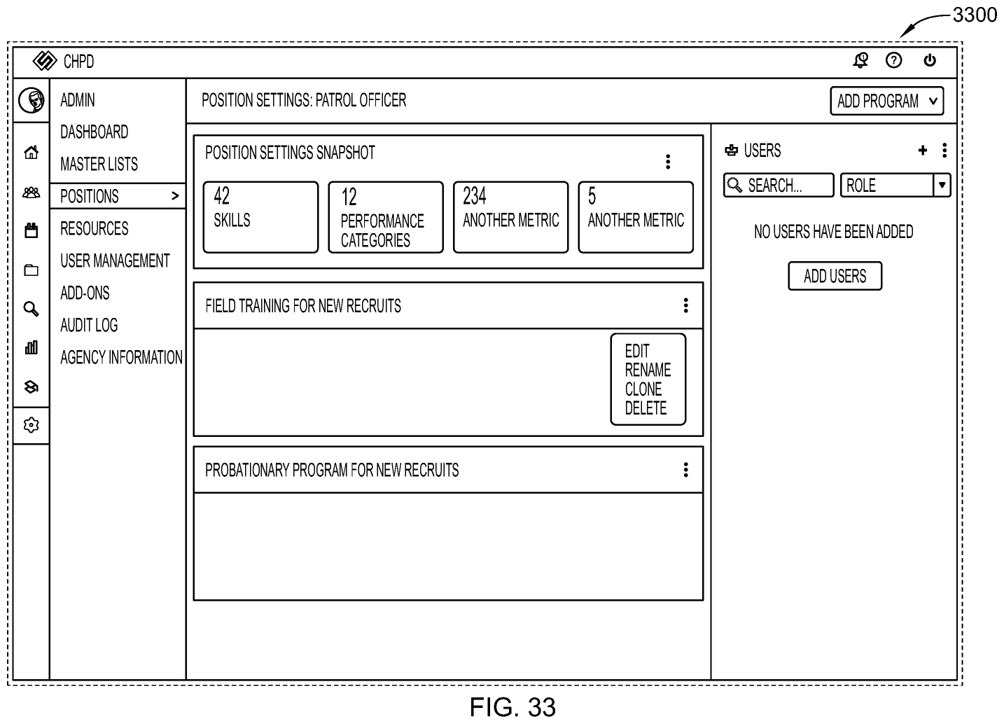

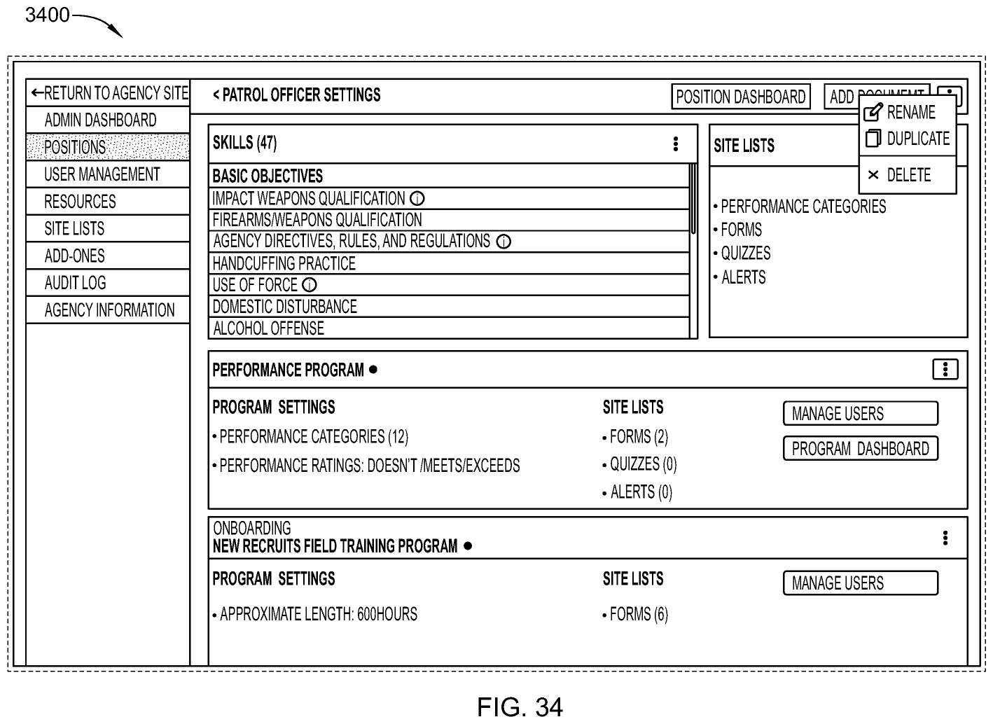

Referring now to FIGS. 32-34, diagrams of user interfaces 3200, 3300, 3400 that may be provided by the system 100 (e.g., based on renderable code and data provided by the server compute device 110 to one or more user compute devices 130, 132, 134, 136) are shown. The interfaces 3200, 3300, 3400 pertain to programs (e.g., employee management programs) that may be created and managed with the system 100. As an example, an organization (e.g., the organization 120 of FIG. 1) may have an employee position titled “Police Officer”, “Patrol Sergeant”, or “Patrol Officer.” Related to that role (employee position) might be certain stages that the employee passes through in that role. Each of those stages may be represented by a corresponding program. Continuing the example, the programs may be “New Hire Pre Academy”, “New Hire Academy”, “New Hire Field Training Program”, “Lateral Employee Field Training Program”, “Probationary Employee Program”, “Return to Duty Program” (e.g., for those on military leave, Family and Medical Leave Act (FMLA) leave, etc.), “Remedial Program” (e.g., for performance improvement), and “Active”. Each program, in the illustrative embodiment, has its own set of required forms and pending tasks. Further, each program may have classes/courses that must be completed by the employee (e.g., the employee in the role/position) in order to complete the corresponding program. Once completed, the employee may progress to another program or may be fired from the organization.

In some embodiments, the system 100 may manage ongoing training for an employee. For example, the system 100 may determine that the employee should attend one or more specified classes (e.g., based on requirements associated with maintaining licensure, based on identified weaknesses in an employee's skill set (e.g., identified by another person associated with the organization, based on an analysis, by the system 100 of performance in across skill sets associated with a position (e.g., job title) of the employee, and/or based on other factors), etc.), monitor an employee's attendance to classes and completion (or lack thereof) of the classes, and track the employee's progress towards satisfying requirements (e.g., state certification requirements, the organization's requirements, etc.) associated with the employee's position (e.g., job title). The system 100 may also be used to create the classes, such as by producing the content using a library of components (e.g., in a process similar to that discussed above), producing the content of the classes from other existing classes, and/or producing the content of the classes from “scratch” (e.g., not incorporating pre-existing components). Relatedly, the system 100 may assess the efficacy of a given class by identifying employees who attended and completed the class, and comparing the performance of people who have completed the class to a reference performance (e.g., compared to their performance prior to attending and completing the class, compared to people who did not take the class, etc.). The system 100 may additionally identify a set of the most effective classes (e.g., classes that provided the most significant correlation between completing the class and improved performance), identify aspects shared in common among those classes, and present information summarizing those common aspects to a user of the system 100. Additionally or alternatively, the system 100 may track learning activities that are performed to increase an employee's skills and competence in a particular area. For example, the system 100 may track a learning activity in which an employee takes part in role playing to practice handling a particular job-related situation (e.g., a simulated traffic stop), is assigned to perform certain learning tasks (e.g., reviewing one or more written policies), is brought as an observer of a bank robbery or other safety related call, or the like. The system 100 may also track grades associated with those learning activities.

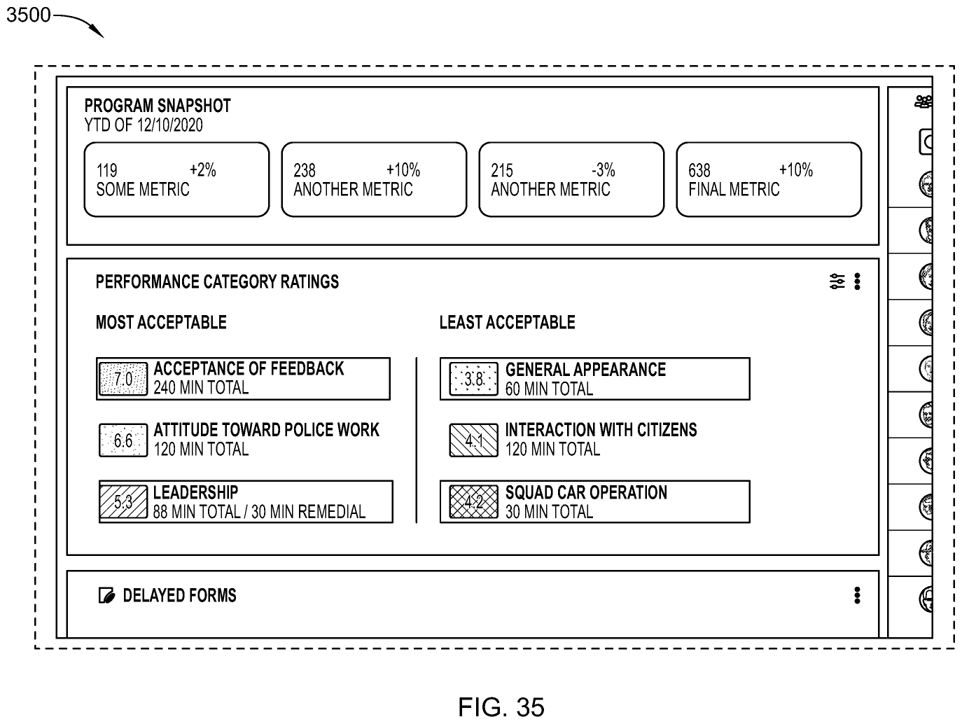

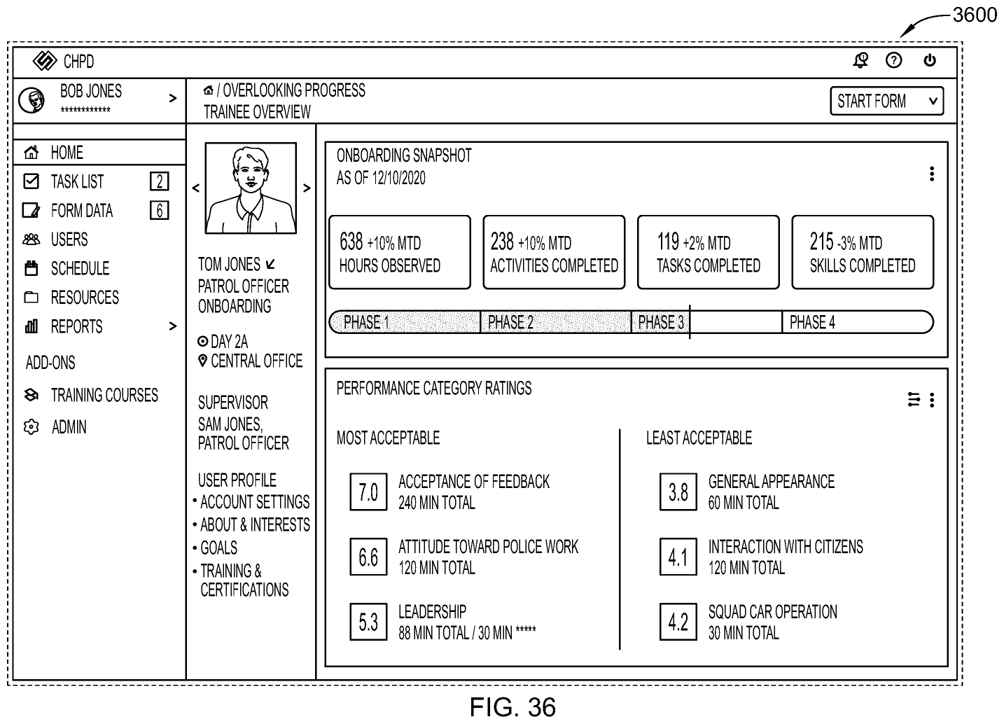

Referring now to FIGS. 35-39, the system 100 may produce user interfaces 3500, 3600, 3700, 3800, 3900 representing dashboards. A dashboard, for example, may summarize information pertaining to an entire program (e.g., performance category information, including average scores and training time, in one user interface). Referring now to FIG. 35, the user interface 3500 represents a dashboard that summarizes information pertaining to an entire program and includes a panel with a program snapshot (e.g., a high level summary in which a number of key metrics are displayed). The user interface 3500 may include one or more additional panels summarizing specific aspects of the program, such as performance category ratings. Dashboards produced by the system 100 can be used to summarize data for a program, a position (e.g., summarizing multiple programs), or all programs and positions for an entire customer site (e.g., organization 120). That is, unlike other systems, the system 100 may generate dashboards that summarize data across multiple program types, such as a field training program, a probation program, and a regular performance program. Referring now to FIG. 36, the system 100 may produce a user interface 3600 representing a dashboard summarizing a single trainee in a single program. The user interface 3600 includes the name, position, office location, and supervisor for the trainee, as well as metrics associated with the trainee's progress in an onboarding program and scores with respect to various activities, tasks, and skills measured within the onboarding program.

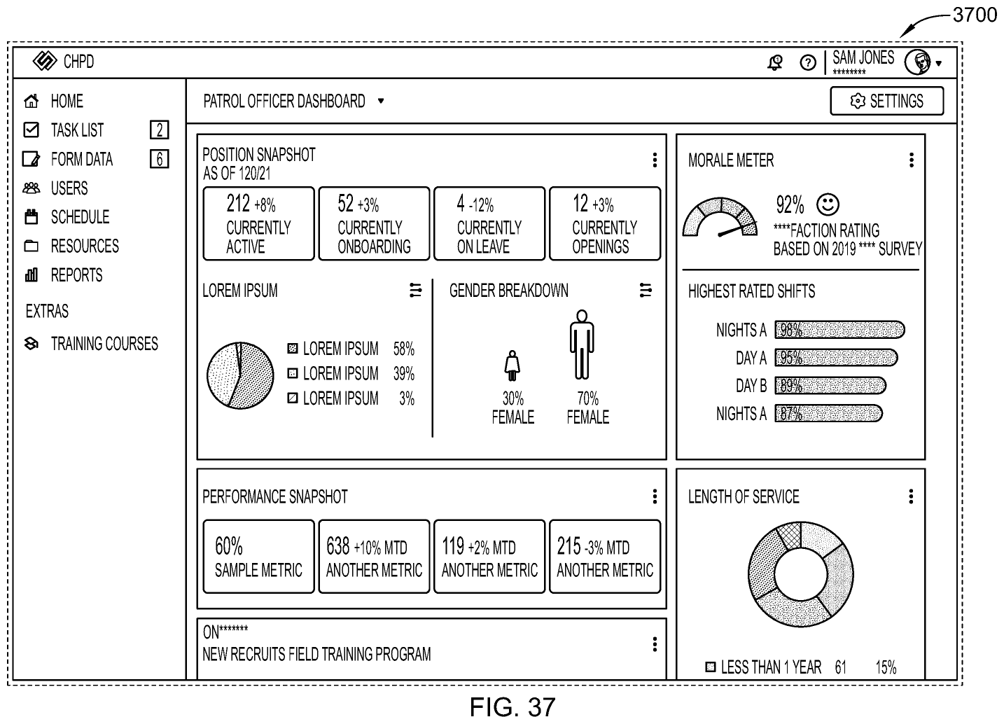

Referring now to FIG. 37, the system 100 may produce a user interface 3700 representing a dashboard summarizing an entire position (e.g., job title). That is, the user interface 3700 summarizes information pertaining to multiple people enrolled in any number of programs associated with the “Patrol Officer” position. The user interface 3700 includes the number of people currently active in the position (i.e., 212 people), the number of people currently onboarding (i.e., 52 people), the number of people currently on leave (i.e., 4 people), and the number of current openings for the position (i.e., 12 openings). The user interface 3700 also includes a gender breakdown (e.g., percentage of people that are female and percentage of people that are male in the position), the average performance of the group of people in the position in multiple areas of skills, activities, and tasks, a visual representation of the morale of the group, how different shifts of people in the position compare, and visual information indicative of how the group of people in the position is broken down by length of service.

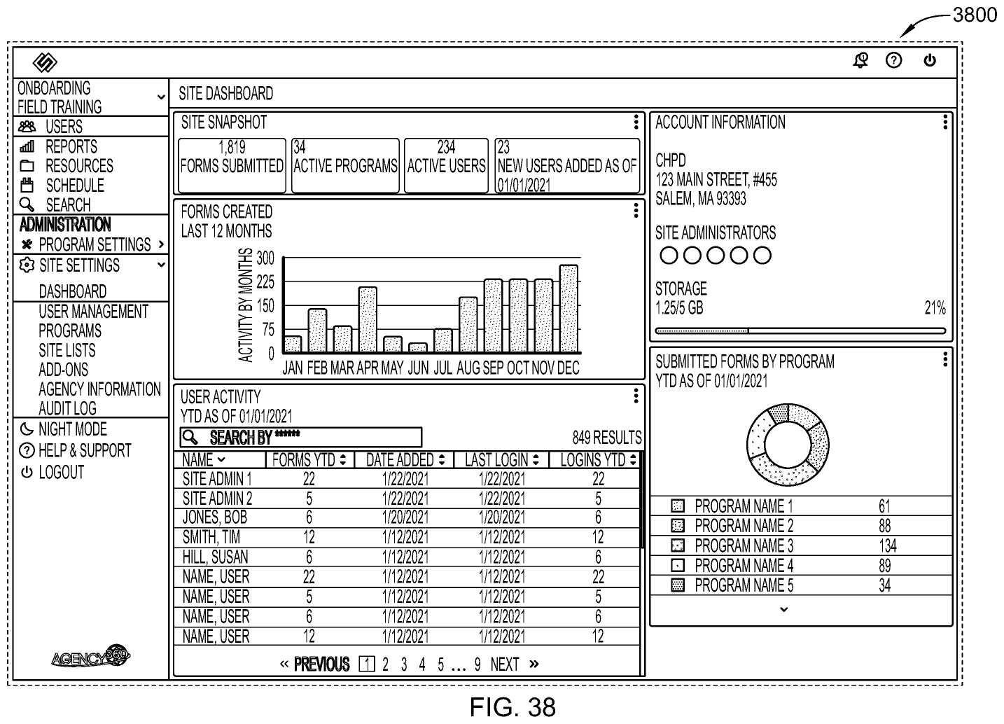

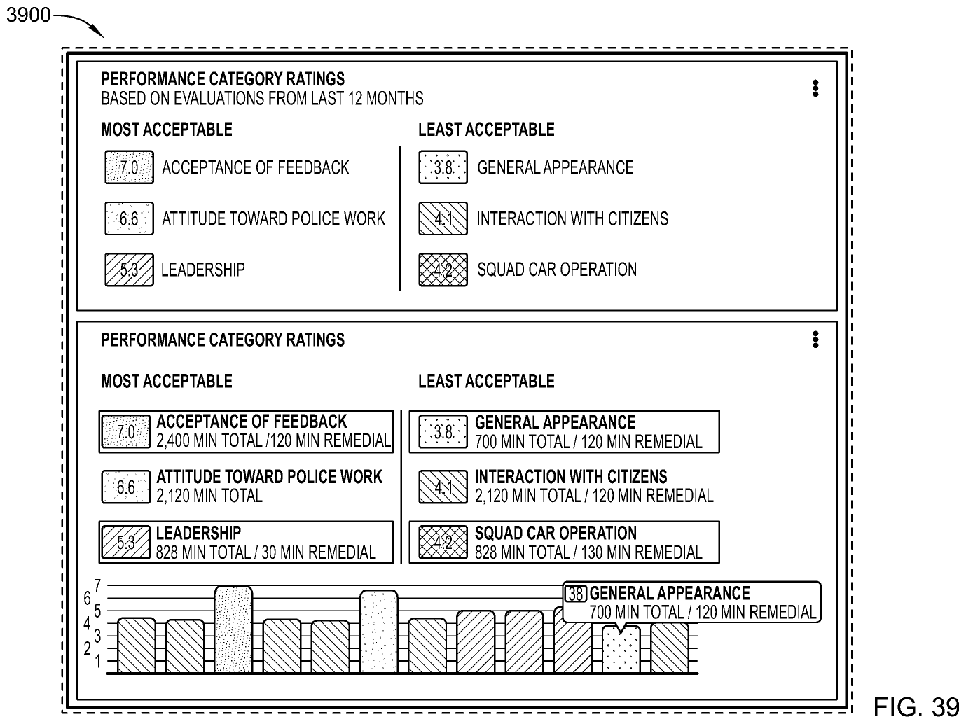

Referring now to FIG. 38, the user interface 3800 represents a dashboard in which performance data for all people enrolled in programs for an entire site (e.g., organization 120) is displayed. That is, information that would otherwise only be available by viewing dashboards associated with each individual person enrolled in a program, or each position, associated with the site (e.g., organization 120) is presented in a global view in the dashboard represented in the user interface 3800. The user interface 3800 also includes information indicative of the level of interaction or use of the system 100 by personnel associated with the site (e.g., the organization 120), such as the number of forms submitted, the number of active programs, the number of active users, and the number of new users added as of a defined date, the number of forms that were created in each month of a given year, logins per user (year to date), and related information. As indicated in the user interface 3900 of FIG. 39, the system 100 may produce a dashboard visually presenting information associated with multiple performance categories, including “Acceptance of Feedback”, “Attitude toward Police Work”, “Leadership”, “General Appearance”, “Interaction with Citizens”, and “Squad Car Operation”. The reported performance may be for a particular person, a set of people (e.g., averages for all trainees associated with a position), or all people associated with a site (e.g., averages for all trainees associated with the organization 120). The information may also be presented in a time-series format in which changes in performance over multiple months or other segments of time are graphically represented.

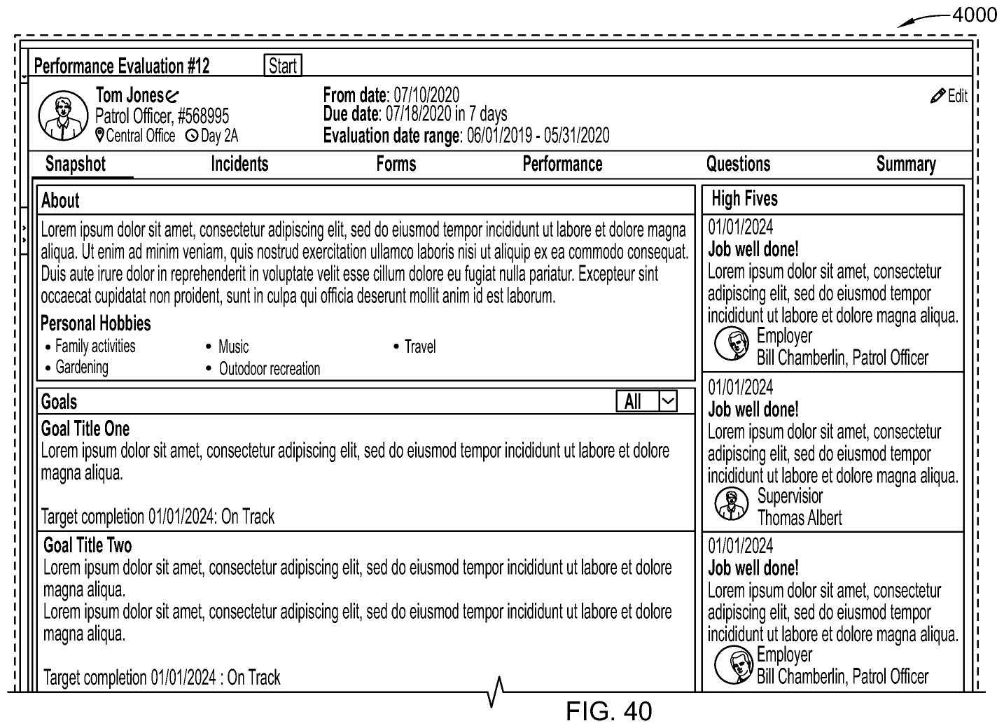

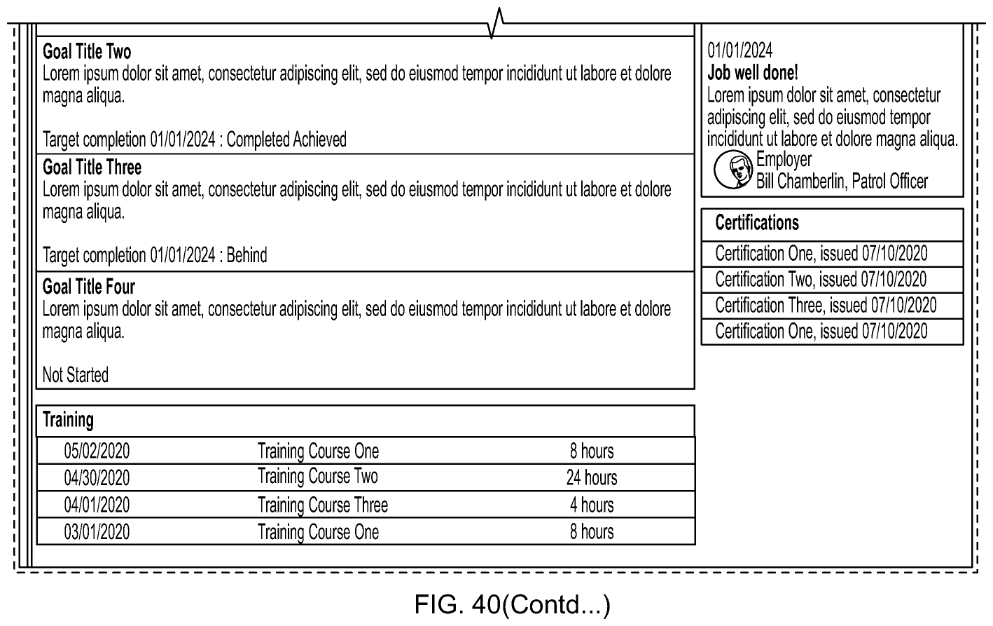

Referring now to FIG. 40, the system 100 may provide a user interface 4000 that combines data from multiple forms (e.g., multiple forms in a traditional employee management program) into a single form. The user interface 4000 is an example performance evaluation form, which is customizable, and imports relevant data that has occurred over a defined time period, regardless of which form was used to enter the data. As such, the system 100 consolidates data from multiple sources (e.g., forms) and provides, through the user interface 4000, a full picture of data to a viewer (e.g., administrator, supervisor, etc.) without requiring the user to individually request data associated with each data source (e.g., data pertaining to each specific form). For example, for a given employee, the system 100 may provide a user interface that indicates that the employee received one or more compliments through corresponding “high five” forms, that a negative incident regarding the employee's performance was reported using a separate form, and that the employee was involved in particular trainings over the course of the preceding twelve months, as reported to the system 100 through yet other forms. In the illustrative embodiment, the user interface 4000 produced by the system 100 additionally includes personal information about the employee to provide the viewer (e.g., administrator, supervisor, etc.) better context to assist with the viewer's evaluation of the employee. The personal information may include, for example, goals and interests of the employee.

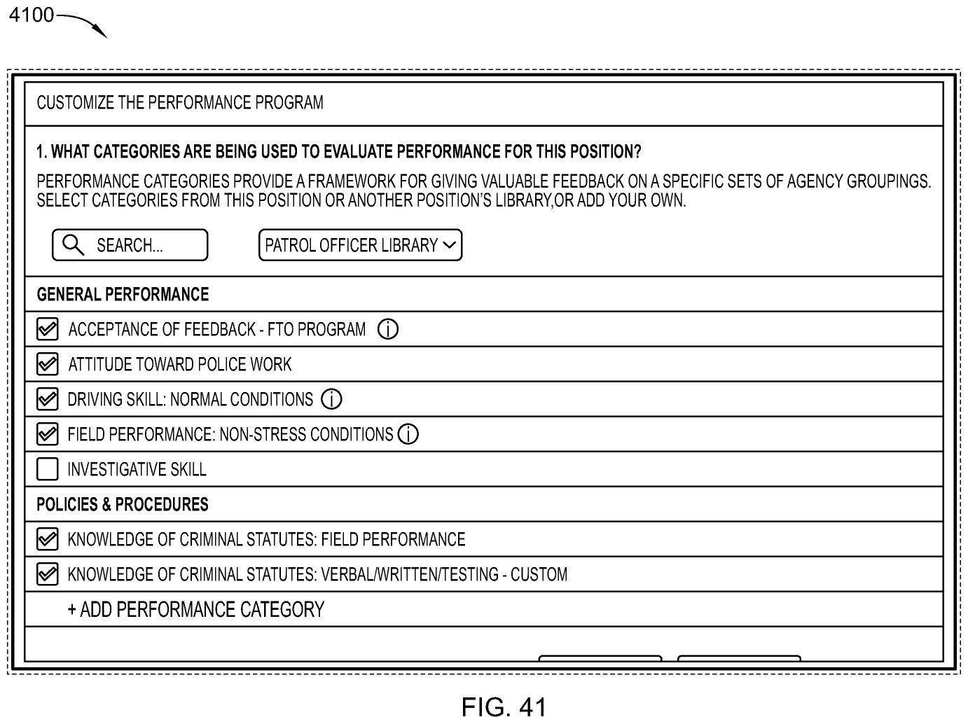

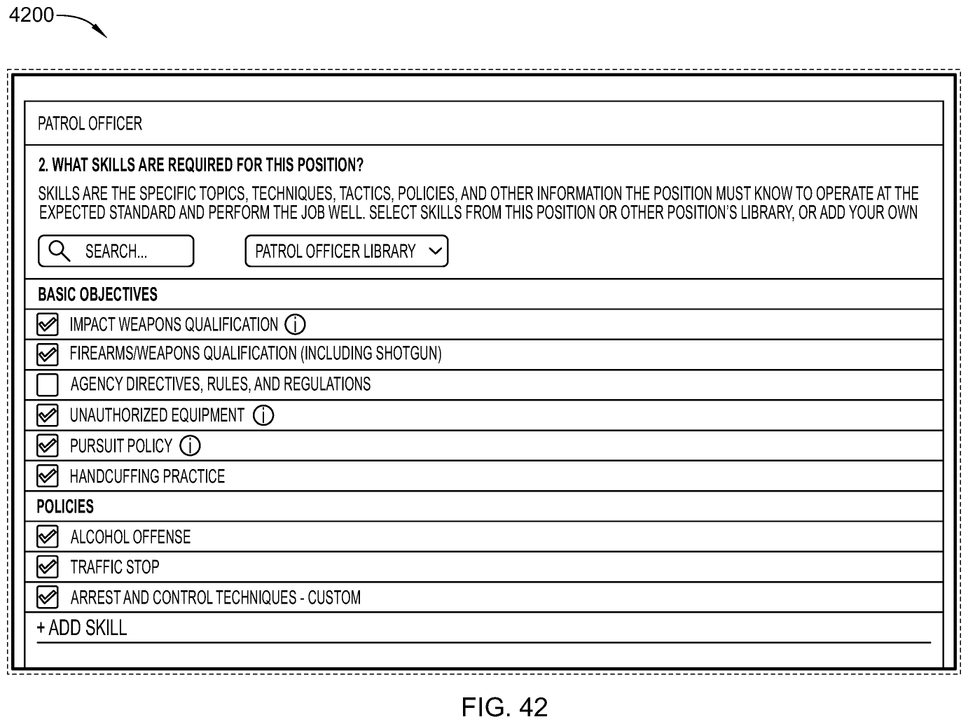

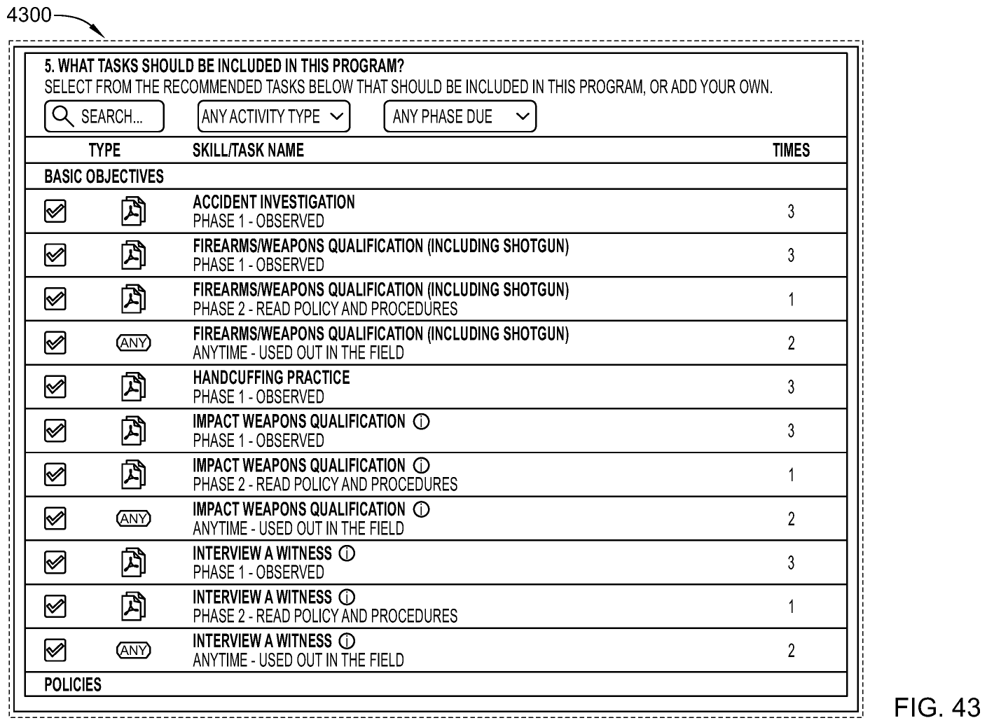

Referring now to FIGS. 41-43, the system 100 may produce user interfaces 4100, 4200, 4300 that enable creation or modification of program based on a library of previously defined forms, performance categories, skills, positions, customer questions, and/or other components. In the example user interface 4100, a user (e.g., administrator) using a user compute device 130, 132, 134, 136 may customize a program by selecting predefined performance categories from one or more libraries (e.g., a patrol officer library, etc.) stored by the system 100 (e.g., by the server compute device 110). The user interface 4100 includes a text box in which a user may enter one or more search terms to find matching performance categories. By selecting a check box associated with a performance category displayed in the user interface 4100, the user may add the corresponding performance category to a corresponding program. Similarly, the user interface 4200 shown in FIG. 42 enables a user to search for and add one or more predefined skills to be evaluated in a program. Further, the user interface 4300 shown in FIG. 43 enables a user to search for and add one or more predefined tasks to a program. Each of the user interfaces 4100, 4200, 4300 also enables the user to create a new performance category, skill, or task, and add it to the program. In the illustrative embodiment, the newly created category, skill, or task is added to a library for potential use in a subsequently created or modified program. The system 100 may present user interfaces 4100, 4200, 4300 as part of a wizard (e.g., a user interface type that presents a user with a sequence of dialog boxes that lead the user through a series of steps) to enable the user to easily combine components (e.g., from a library of components) to create a program that fits the user's needs, without requiring the user to incorporate other components that are not needed (e.g., as may be the case if the program was generated from a template (e.g., a copy of another employee management program)).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to provide, to a user compute device, a dashboard associated with an employee management program for managing personnel of a public safety organization; receive, from the user compute device, user input associated with the dashboard; and update, as a function of the user input, the employee management program.

Example 2 includes the subject matter of Example 1, and wherein to provide a dashboard comprises to provide a dashboard for use in an employee management program for a law enforcement organization, an emergency medical services organization, a correctional facility, a 911 dispatch center, or a private security organization.

Example 3 includes the subject matter of any of Examples 1 and 2, and wherein to provide a dashboard comprises to send renderable code to a user compute device to display the dashboard in a format defined as a function of a form factor of the user compute device.

Example 4 includes the subject matter of any of Examples 1-3, and wherein to provide a dashboard comprises to provide a dashboard for a field training program.

Example 5 includes the subject matter of any of Examples 1-4, and wherein to provide a dashboard comprises to provide a dashboard for a post field training program.

Example 6 includes the subject matter of any of Examples 1-5, and wherein to provide a dashboard comprises to provide a dashboard for a probationary program or a performance evaluation program.

Example 7 includes the subject matter of any of Examples 1-6, and wherein to provide a dashboard comprises to provide a dashboard having a set of functions adapted to a role of a user of the user compute device.

Example 8 includes the subject matter of any of Examples 1-7, and wherein to provide a dashboard comprises to provide a dashboard having a set of functions adapted for an administrator or coordinator.

Example 9 includes the subject matter of any of Examples 1-8, and wherein to provide a dashboard comprises to provide a dashboard to create or modify an employee management program.

Example 10 includes the subject matter of any of Examples 1-9, and wherein to provide a dashboard comprises to provide a dashboard to define data to be collected as part of an employee management program.

Example 11 includes the subject matter of any of Examples 1-10, and wherein the circuitry is further configured to identify, based on an existing employee management program, the data to be collected.

Example 12 includes the subject matter of any of Examples 1-11, and wherein the circuitry is further configured to identify, from one or more paper-based forms, data to be collected as part of the employee management program.

Example 13 includes the subject matter of any of Examples 1-12, and wherein the circuitry is further configured to generate one or more forms as a function of the data to be collected.

Example 14 includes the subject matter of any of Examples 1-13, and wherein to generate one or more forms comprises to generate a form from a combination of multiple paper-based forms.

Example 15 includes the subject matter of any of Examples 1-14, and wherein to provide a dashboard comprises to provide a dashboard to establish a trigger for an alert based on a progress of an employee in the employee management program.

Example 16 includes the subject matter of any of Examples 1-15, and wherein to provide a dashboard to establish a trigger comprises to provide a dashboard to establish one or more user created triggers.

Example 17 includes the subject matter of any of Examples 1-16, and wherein to provide a dashboard comprises to provide a dashboard having a set of functions adapted for a trainer or supervisor.

Example 18 includes the subject matter of any of Examples 1-17, and wherein to provide a dashboard comprises to provide a dashboard to enter data regarding an employee using a form associated with the employee management program.

Example 19 includes the subject matter of any of Examples 1-18, and wherein to provide a dashboard comprises to provide a dashboard to view progress of one or more employees in the employee management program.

Example 20 includes the subject matter of any of Examples 1-19, and wherein to provide a dashboard comprises to provide a dashboard having a set of functions adapted for an employee.

Example 21 includes the subject matter of any of Examples 1-20, and wherein to provide a dashboard having a set of functions adapted for an employee comprises to provide one or more user interface elements to enable the employee to view an evaluation of the employee.

Example 22 includes the subject matter of any of Examples 1-21, and wherein to provide a dashboard having a set of functions adapted for an employee comprises to provide one or more user interface elements to enable an employee to provide feedback on the employee management program.

Example 23 includes the subject matter of any of Examples 1-22, and wherein to provide a dashboard further comprises to provide one or more alerts indicative of an action to be taken by a user of the compute device.

Example 24 includes the subject matter of any of Examples 1-23, and wherein to provide a dashboard further comprises to provide a resources area enabling a user of the user compute device to access files that are shared with one or more other users.

Example 25 includes the subject matter of any of Examples 1-24, and wherein to provide a resources area comprises to provide a resources area enabling the user to access a map of a geographic area or a floor plan of a building.

Example 26 includes the subject matter of any of Examples 1-25, and wherein to provide a dashboard further comprises to provide a mentor area for associating a mentor with an employee.

Example 27 includes the subject matter of any of Examples 1-26, wherein the circuitry is further configured to match a first person associated with the public safety organization with a second person, for training, mentorship, or supervision based on one or more characteristics of the first person and the second person.

Example 28 includes the subject matter of any of Examples 1-27, and wherein to provide a dashboard further comprises to provide a schedule area to display a schedule associated with a user of the user compute device.

Example 29 includes the subject matter of any of Examples 1-28, and wherein to provide a dashboard further comprises to provide a search area to display search results for data related to the employee management program.

Example 30 includes the subject matter of any of Examples 1-29, and wherein to receive user input comprises to receive user input to create or modify an employee management program, receive progress data associated with an employee, receive a selection of a selectable predefined response for a text entry field, receive a selection of a mentor to be assigned to an employee, or receive a search request.

Example 31 includes the subject matter of any of Examples 1-30, and wherein to perform a responsive action comprises to create a new employee management program, modify an existing employee management program, set or modify one or more triggers for an alert associated with an employee management program, update stored progress data associated with an employee based on received progress data, provide an interface that enables communication between an employee and an assigned mentor, provide search results, provide a visualization of progress data for one or more employees, or provide a requested resource.

Example 32 includes the subject matter of any of Examples 1-31, and wherein to perform a responsive action comprises to perform an action based on a trigger, wherein the action is defined in the employee management program in association with the trigger.

Example 33 includes the subject matter of any of Examples 1-32, and wherein to perform an action based on a trigger comprises to update the dashboard to indicate satisfaction of the trigger.

Example 34 includes the subject matter of any of Examples 1-33, and wherein to perform an action based on a trigger comprises to send a communication to a user of the compute device indicating satisfaction of the trigger.

Example 35 includes the subject matter of any of Examples 1-34, and wherein to provide a dashboard comprises to provide a dashboard to present a library of previously defined program components to create or modify an employee management program.

Example 36 includes the subject matter of any of Examples 1-35, and wherein to provide a dashboard comprises to provide a wizard to create or modify an employee management program.

Example 37 includes the subject matter of any of Examples 1-36, and wherein to provide a dashboard comprises to provide a dashboard that indicates an eligibility of an employee for a target position.

Example 38 includes the subject matter of any of Examples 1-37, and wherein to provide a dashboard comprises to provide a dashboard to display the progress of at least one employee associated with a position.

Example 39 includes the subject matter of any of Examples 1-38, and wherein to provide a dashboard comprises to provide a dashboard to concurrently display progress information for multiple employee management programs associated with the public safety organization.

Example 40 includes the subject matter of any of Examples 1-39, and wherein to provide a dashboard comprises to provide a dashboard to concurrently display progress information for all employee management programs associated with the public safety organization.

Example 41 includes the subject matter of any of Examples 1-40, and wherein the circuitry is further to determine an identified goal of an employee; identity, from a set of people, a person that has satisfied the identified goal of the employee; and assign, in response to identification of the person, the identified person as a mentor, trainer, or supervisor of the employee.

Example 42 includes the subject matter of any of Examples 1-41, and wherein to identity, from a set of people, a person that has satisfied the identified goal of the employee comprises to identify a person that has achieved a target job title identified by the employee.

Example 43 includes the subject matter of any of Examples 1-42, and wherein to provide a dashboard comprises to provide a dashboard that displays progress information pertaining to multiple employee management programs associated with an identified position.

Example 44 includes the subject matter of any of Examples 1-43, and wherein to provide a dashboard comprises to provide a dashboard that displays information collected from multiple different forms.

Example 45 includes the subject matter of any of Examples 1-44, and wherein the circuitry is further configured to assist an employee in determining a personality type of the employee and display, to a person assigned to the employee, the determined personality type of the employee.

Example 46 includes the subject matter of any of Examples 1-45, and wherein the circuitry is further configured to determine additional contextual information about the employee including at least one of interests, hobbies, and goals of the employee and display the determined additional context to a person associated with the organization.

Example 47 includes a method comprising providing, by a compute device and to a user compute device, a dashboard associated with an employee management program for managing personnel of a public safety organization; receiving, by the compute device and from the user compute device, user input associated with the dashboard; and updating, by the compute device and as a function of the user input, the employee management program.

Example 48 includes the subject matter of Example 47, and wherein providing a dashboard comprises providing a dashboard for use in an employee management program for a law enforcement organization, an emergency medical services organization, a correctional facility, a 911 dispatch center, or a private security organization.

Example 49 includes the subject matter of any of Examples 47 and 48, and wherein providing a dashboard comprises sending renderable code to a user compute device to display the dashboard in a format defined as a function of a form factor of the user compute device.

Example 50 includes the subject matter of any of Examples 47-49, and wherein providing a dashboard comprises providing a dashboard for a field training program.

Example 51 includes the subject matter of any of Examples 47-50, and wherein providing a dashboard comprises providing a dashboard for a post field training program.

Example 52 includes the subject matter of any of Examples 47-51, and wherein providing a dashboard comprises providing a dashboard for a probationary program or a performance evaluation program.

Example 53 includes the subject matter of any of Examples 47-52, and wherein providing a dashboard comprises providing a dashboard having a set of functions adapted to a role of a user of the user compute device.

Example 54 includes the subject matter of any of Examples 47-53, and wherein providing a dashboard comprises providing a dashboard having a set of functions adapted for an administrator or coordinator.

Example 55 includes the subject matter of any of Examples 47-54, and wherein providing a dashboard comprises providing a dashboard to create or modify an employee management program.

Example 56 includes the subject matter of any of Examples 47-55, and wherein providing a dashboard comprises providing a dashboard to define data to be collected as part of an employee management program.

Example 57 includes the subject matter of any of Examples 47-56, and further including identifying, by the compute device and based on an existing employee management program, the data to be collected.

Example 58 includes the subject matter of any of Examples 47-57, and further including identifying, by the compute device and from one or more paper-based forms, data to be collected as part of the employee management program.

Example 59 includes the subject matter of any of Examples 47-58, and further including generating, by the compute device, one or more forms as a function of the data to be collected.

Example 60 includes the subject matter of any of Examples 47-59, and wherein generating one or more forms comprises generating a form from a combination of multiple paper-based forms.

Example 61 includes the subject matter of any of Examples 47-60, and wherein providing a dashboard comprises providing a dashboard to establish a trigger for an alert based on a progress of an employee in the employee management program.

Example 62 includes the subject matter of any of Examples 47-61, and wherein providing a dashboard to establish a trigger comprises providing a dashboard to establish one or more user created triggers.

Example 63 includes the subject matter of any of Examples 47-62, and wherein providing a dashboard comprises providing a dashboard having a set of functions adapted for a trainer or supervisor.

Example 64 includes the subject matter of any of Examples 47-63, and wherein providing a dashboard comprises providing a dashboard to enter data regarding an employee using a form associated with the employee management program.

Example 65 includes the subject matter of any of Examples 47-64, and wherein providing a dashboard comprises providing a dashboard to view progress of one or more employees in the employee management program.

Example 66 includes the subject matter of any of Examples 47-65, and wherein providing a dashboard comprises providing a dashboard having a set of functions adapted for an employee.

Example 67 includes the subject matter of any of Examples 47-66, and wherein providing a dashboard having a set of functions adapted for an employee comprises providing one or more user interface elements to enable the employee to view an evaluation of the employee.

Example 68 includes the subject matter of any of Examples 47-67, and wherein providing a dashboard having a set of functions adapted for an employee comprises providing one or more user interface elements to enable an employee to provide feedback on the employee management program.

Example 69 includes the subject matter of any of Examples 47-68, and wherein providing a dashboard further comprises providing one or more alerts indicative of an action to be taken by a user of the user compute device.

Example 70 includes the subject matter of any of Examples 47-69, and wherein providing a dashboard further comprises providing a resources area enabling a user of the user compute device to access files that are shared with one or more other users.

Example 71 includes the subject matter of any of Examples 47-70, and wherein providing a resources area comprises providing a resources area enabling the user to access a map of a geographic area or a floor plan of a building.

Example 72 includes the subject matter of any of Examples 47-71, and wherein providing a dashboard further comprises providing a mentor area for associating a mentor with an employee.

Example 73 includes the subject matter of any of Examples 47-72, further comprising matching, by the compute device, a first person associated with the public safety organization with a second person, for training, mentorship, or supervision based on one or more characteristics of the first person and the second person.

Example 74 includes the subject matter of any of Examples 47-73, and wherein providing a dashboard further comprises providing a schedule area to display a schedule associated with a user of the user compute device.

Example 75 includes the subject matter of any of Examples 47-74, and wherein providing a dashboard further comprises providing a search area to display search results for data related to the employee management program.

Example 76 includes the subject matter of any of Examples 47-75, and wherein receiving user input comprises receiving user input to create or modify an employee management program, receiving progress data associated with an employee, receiving a selection of a selectable predefined response for a text entry field, receiving a selection of a mentor to be assigned to an employee, or receiving a search request.

Example 77 includes the subject matter of any of Examples 47-76, wherein performing a responsive action comprises creating a new employee management program, modifying an existing employee management program, setting or modifying one or more triggers for an alert associated with an employee management program, updating stored progress data associated with an employee based on received progress data, providing an interface that enables communication between an employee and an assigned mentor, providing search results, providing a visualization of progress data for one or more employees, or providing a requested resource.

Example 78 includes the subject matter of any of Examples 47-77, and wherein performing a responsive action comprises performing an action based on a trigger, wherein the action is defined in the employee management program in association with the trigger.

Example 79 includes the subject matter of any of Examples 47-78, and wherein performing an action based on a trigger comprises updating the dashboard to indicate satisfaction of the trigger.

Example 80 includes the subject matter of any of Examples 47-79, and wherein performing an action based on a trigger comprises sending a communication to a user of the compute device indicating satisfaction of the trigger.

Example 81 includes the subject matter of any of Examples 47-80, and wherein providing a dashboard comprises providing a dashboard to present a library of previously defined program components to create or modify an employee management program.

Example 82 includes the subject matter of any of Examples 47-81, and wherein providing a dashboard comprises providing a wizard to create or modify an employee management program.

Example 83 includes the subject matter of any of Examples 47-82, and wherein providing a dashboard comprises providing a dashboard that indicates an eligibility of an employee for a target position.

Example 84 includes the subject matter of any of Examples 47-83, and wherein providing a dashboard comprises providing a dashboard to display the progress of at least one employee associated with a position.

Example 85 includes the subject matter of any of Examples 47-84, and wherein providing a dashboard comprises providing a dashboard to concurrently display progress information for multiple employee management programs associated with the public safety organization.

Example 86 includes the subject matter of any of Examples 47-85, and wherein providing a dashboard comprises providing a dashboard to concurrently display progress information for all employee management programs associated with the public safety organization.

Example 87 includes the subject matter of any of Examples 47-86, and further including determining, by the compute device, an identified goal of an employee; identifying, by the compute device and from a set of people, a person that has satisfied the identified goal of the employee; and assigning, by the compute device and in response to identification of the person, the identified person as a mentor, trainer, or supervisor of the employee.

Example 88 includes the subject matter of any of Examples 47-87, and wherein identifying, from a set of potential mentors, a mentor that has satisfied the identified goal of the trainee comprises identifying a mentor that has achieved a target job title identified by the trainee.

Example 89 includes the subject matter of any of Examples 47-88, and wherein providing a dashboard comprises providing a dashboard that displays progress information pertaining to multiple employee management programs associated with an identified position.

Example 90 includes the subject matter of any of Examples 47-89, and wherein providing a dashboard comprises providing a dashboard that displays information collected from multiple different forms.

Example 91 includes the subject matter of any of Examples 47-90, and further including assisting, by the compute device, a trainee in determining a personality type of the employee and displaying, to a person assigned to the employee, the determined personality type of the employee.

Example 92 includes the subject matter of any of Examples 47-91, and further including determining, by the compute device, additional contextual information about the employee including at least one of interests, hobbies, and goals of the trainee and display the determined additional context to a person associated with the organization.

Example 93 includes one or more machine-readable storage media comprising a plurality of instructions stored thereon that, in response to being executed, cause a compute device to provide, to a user compute device, a dashboard associated with an employee management program for managing personnel of a public safety organization; receive, from the user compute device, user input associated with the dashboard; and update, as a function of the user input, the employee management program.

Example 94 includes the subject matter of Example 93, and wherein to provide a dashboard comprises to provide a dashboard for use in an employee management program for a law enforcement organization, an emergency medical services organization, a correctional facility, a 911 dispatch center, or a private security organization.

Example 95 includes the subject matter of any of Examples 93 and 94, and wherein to provide a dashboard comprises to send renderable code to a user compute device to display the dashboard in a format defined as a function of a form factor of the user compute device.

Example 96 includes the subject matter of any of Examples 93-95, and wherein to provide a dashboard comprises to provide a dashboard for a field training program.

Example 97 includes the subject matter of any of Examples 93-96, and wherein to provide a dashboard comprises to provide a dashboard for a post field training program.

Example 98 includes the subject matter of any of Examples 93-97, and wherein to provide a dashboard comprises to provide a dashboard for a probationary program or a performance evaluation program.

Example 99 includes the subject matter of any of Examples 93-98, and wherein to provide a dashboard comprises to provide a dashboard having a set of functions adapted to a role of a user of the user compute device.

Example 100 includes the subject matter of any of Examples 93-99, and wherein to provide a dashboard comprises to provide a dashboard having a set of functions adapted for an administrator or coordinator.

Example 101 includes the subject matter of any of Examples 93-100, and wherein to provide a dashboard comprises to provide a dashboard to create or modify an employee management program.

Example 102 includes the subject matter of any of Examples 93-101, and wherein to provide a dashboard comprises to provide a dashboard to define data to be collected as part of an employee management program.

Example 103 includes the subject matter of any of Examples 93-102, and wherein the instructions further cause the compute device to identify, based on an existing employee management program, the data to be collected.

Example 104 includes the subject matter of any of Examples 93-103, and wherein the instructions further cause the compute device to identify, from one or more paper-based forms, data to be collected as part of the employee management program.

Example 105 includes the subject matter of any of Examples 93-104, and wherein the instructions further cause the compute device to generate one or more forms as a function of the data to be collected.

Example 106 includes the subject matter of any of Examples 93-105, and wherein to generate one or more forms comprises to generate a form from a combination of multiple paper-based forms.

Example 107 includes the subject matter of any of Examples 93-106, and wherein to provide a dashboard comprises to provide a dashboard to establish a trigger for an alert based on a progress of an employee in the employee management program.

Example 108 includes the subject matter of any of Examples 93-107, and wherein to provide a dashboard to establish a trigger comprises to provide a dashboard to establish one or more user created triggers.

Example 109 includes the subject matter of any of Examples 93-108, and wherein to provide a dashboard comprises to provide a dashboard having a set of functions adapted for a trainer or supervisor.

Example 110 includes the subject matter of any of Examples 93-109, and wherein to provide a dashboard comprises to provide a dashboard to enter data regarding an employee using a form associated with the employee management program.

Example 111 includes the subject matter of any of Examples 93-110, and wherein to provide a dashboard comprises to provide a dashboard to view progress of one or more employees in the employee management program.

Example 112 includes the subject matter of any of Examples 93-111, and wherein to provide a dashboard comprises to provide a dashboard having a set of functions adapted for an employee.

Example 113 includes the subject matter of any of Examples 93-112, and wherein to provide a dashboard having a set of functions adapted for an employee comprises to provide one or more user interface elements to enable the employee to view an evaluation of the employee.

Example 114 includes the subject matter of any of Examples 93-113, and wherein to provide a dashboard having a set of functions adapted for an employee comprises to provide one or more user interface elements to enable an employee to provide feedback on the employee management program.

Example 115 includes the subject matter of any of Examples 93-114, and wherein to provide a dashboard further comprises to provide one or more alerts indicative of an action to be taken by a user of the compute device.

Example 116 includes the subject matter of any of Examples 93-115, and wherein to provide a dashboard further comprises to provide a resources area enabling a user of the compute device to access files that are shared with one or more other users.

Example 117 includes the subject matter of any of Examples 93-116, and wherein to provide a resources area comprises to provide a resources area enabling the user to access a map of a geographic area or a floor plan of a building.

Example 118 includes the subject matter of any of Examples 93-117, and wherein to provide a dashboard further comprises to provide a mentor area for associating a mentor with an employee.

Example 119 includes the subject matter of any of Examples 93-118, and wherein the instructions further cause the compute device to match a first person associated with the public safety organization with a second person, for training, mentorship, or supervision based on one or more characteristics of the first person and the second person.

Example 120 includes the subject matter of any of Examples 93-119, and wherein to provide a dashboard further comprises to provide a schedule area to display a schedule associated with a user of the user compute device.

Example 121 includes the subject matter of any of Examples 93-120, and wherein to provide a dashboard further comprises to provide a search area to display search results for data related to the employee management program.

Example 122 includes the subject matter of any of Examples 93-121, and wherein to receive user input comprises to receive user input to create or modify an employee management program, receive progress data associated with an employee, receive a selection of a selectable predefined response for a text entry field, receive a selection of a mentor to be assigned to an employee, or receive a search request.

Example 123 includes the subject matter of any of Examples 93-122, and wherein to perform a responsive action comprises to create a new employee management program, modify an existing employee management program, set or modify one or more triggers for an alert associated with an employee management program, update stored progress data associated with an employee based on received progress data, provide an interface that enables communication between an employee and an assigned mentor, provide search results, provide a visualization of progress data for one or more employee, or provide a requested resource.

Example 124 includes the subject matter of any of Examples 93-123, and wherein to perform a responsive action comprises to perform an action based on a trigger, wherein the action is defined in the employee management program in association with the trigger.

Example 125 includes the subject matter of any of Examples 93-124, and wherein to perform an action based on a trigger comprises to update the dashboard to indicate satisfaction of the trigger.

Example 126 includes the subject matter of any of Examples 93-125, and wherein to perform an action based on a trigger comprises to send a communication to a user of the compute device indicating satisfaction of the trigger.

Example 127 includes the subject matter of any of Examples 93-126, and wherein to provide a dashboard comprises to provide a dashboard to present a library of previously defined program components to create or modify an employee management program.

Example 128 includes the subject matter of any of Examples 93-127, and wherein to provide a dashboard comprises to provide a wizard to create or modify an employee management program.

Example 129 includes the subject matter of any of Examples 93-128, and wherein to provide a dashboard comprises to provide a dashboard that indicates an eligibility of an employee for a target position.

Example 130 includes the subject matter of any of Examples 93-129, and wherein to provide a dashboard comprises to provide a dashboard to display the progress of at least one employee associated with a position.

Example 131 includes the subject matter of any of Examples 93-130, and wherein to provide a dashboard comprises to provide a dashboard to concurrently display progress information for multiple employee management programs associated with the public safety organization.

Example 132 includes the subject matter of any of Examples 93-131, and wherein to provide a dashboard comprises to provide a dashboard to concurrently display progress information for all employee management programs associated with the public safety organization.

Example 133 includes the subject matter of any of Examples 93-132, and wherein the instructions further cause the compute device to determine an identified goal of an employee; identity, from a set of people, a person that has satisfied the identified goal of the employee; and assign, in response to identification of the person, the identified person as a mentor, trainer, or supervisor of the employee.

Example 134 includes the subject matter of any of Examples 93-133, and wherein to identity, from a set of people, a person that has satisfied the identified goal of the employee comprises to identify a person that has achieved a target job title identified by the employee.

Example 135 includes the subject matter of any of Examples 93-134, and wherein to provide a dashboard comprises to provide a dashboard that displays progress information pertaining to multiple employee management programs associated with an identified position.

Example 136 includes the subject matter of any of Examples 93-135, and wherein to provide a dashboard comprises to provide a dashboard that displays information collected from multiple different forms.

Example 137 includes the subject matter of any of Examples 93-136, and wherein the instructions further cause the compute device to assist an employee in determining a personality type of the employee and display, to a person assigned to the employee, the determined personality type of the employee.

Example 138 includes the subject matter of any of Examples 93-137, and wherein the instructions further cause the compute device to determine additional contextual information about the employee including at least one of interests, hobbies, and goals of the employee and display the determined additional context to a person associated with the organization.

1. A compute device comprising:
circuitry configured to:
provide, to a user compute device, a dashboard associated with an employee management program for managing personnel of a public safety organization;
receive, from the user compute device, user input associated with the dashboard; and
update, as a function of the user input, the employee management program.

2. The compute device of claim 1, wherein to provide a dashboard comprises to provide a dashboard for use in an employee management program for a law enforcement organization, an emergency medical services organization, a correctional facility, a 911 dispatch center, or a private security organization.

3. The compute device of claim 1, wherein to provide a dashboard comprises to provide a dashboard to create or modify an employee management program.

4. The compute device of claim 1, wherein to provide a dashboard comprises to provide a dashboard to establish one or more user created triggers.

5. The compute device of claim 1, wherein to provide a dashboard comprises to provide a dashboard to present a library of previously defined program components to create or modify an employee management program.

6. The compute device of claim 5, wherein the circuitry is further configured to provide a wizard to create or modify an employee management program.

7. The compute device of claim 1, wherein to provide a dashboard comprises to provide a dashboard that indicates an eligibility of an employee for a target position.

8. The compute device of claim 1, wherein to provide a dashboard comprises to provide a dashboard to concurrently display progress information for multiple employee management programs associated with the public safety organization.

9. The compute device of claim 1, wherein to provide a dashboard comprises to provide a dashboard to concurrently display progress information for all employee management programs associated with the public safety organization.

10. The compute device of claim 1, wherein the circuitry is further configured to match a first person associated with the public safety organization with a second person, for training, mentorship, or supervision based on one or more characteristics of the first person and the second person.

11. The compute device of claim 1, wherein the circuitry is further configured to:
determine an identified goal of an employee;
identity, from a set of people, a person that has satisfied the identified goal of the employee; and
assign, in response to identification of the person, the identified person as a mentor trainer, or supervisor of the employee.

12. The compute device of claim 11, wherein to identity, from a set of people, a person that has satisfied the identified goal of the employee comprises to identify a person that has achieved a target job title identified by the employee.

13. The compute device of claim 1, wherein to provide a dashboard comprises to provide a dashboard that displays progress information pertaining to multiple employee management programs associated with an identified position.

14. The compute device of claim 1, wherein the circuitry is further to manage one or more classes associated with ongoing education or training of an employee.

15. The compute device of claim 1, wherein the circuitry is further configured to assist an employee in determining a personality type of the employee and display, to a person associated with the organization and assigned to the employee, the determined personality type of the employee.

16. The compute device of claim 15, wherein the circuitry is further configured to determine additional contextual information about the employee including at least one of interests, hobbies, and goals of the employee and display the determined additional context to a person associated with the organization.

17. The compute device of claim 1, wherein the circuitry is further configured to track one or more learning activities assigned to an employee.

18. A method comprising:
providing, by a compute device and to a user compute device, a dashboard associated with an employee management program for managing personnel of a public safety organization;
receiving, by the compute device and from the user compute device, user input associated with the dashboard; and
updating, by the compute device and as a function of the user input, the employee management program.

19. The method of claim 18, wherein providing a dashboard comprises providing a dashboard for use in an employee management program for a law enforcement organization, an emergency medical services organization, a correctional facility, a 911 dispatch center, or a private security organization.

20. One or more machine-readable storage media comprising a plurality of instructions stored thereon that, in response to being executed, cause a compute device to:
provide, to a user compute device, a dashboard associated with an employee management program for managing personnel of a public safety organization;
receive, from the user compute device, user input associated with the dashboard;
update, as a function of the user input, the employee management program.
